(19) United States
(12) Patent Application Publication
(10) Pub. No.: US 2025/0385325 A1
(43) Pub. Date: Dec. 18, 2025

(54) POWER ELECTRONIC INTELLIGENT BATTERY UNIT

(71) Applicant: SHANGHAI JIAO TONG UNIVERSITY, Shanghai (CN)

(72) Inventors: Rui LI, Shanghai (CN); Hongyang XIE, Shanghai (CN); Jiatao YANG, Shanghai (CN); Xiqi WU, Shanghai (CN); Cheng PENG, Shanghai (CN)

(73) Assignee: SHANGHAI JIAO TONG UNIVERSITY, Shanghai (CN)

(21) Appl. No.: 18/035,935

(22) PCT Filed: Oct. 22, 2021
(86) PCT No.: PCT/CN2021/125613

§ 371 Date: May 9, 2023

(30) Foreign Application Priority Data
Dec. 1, 2020 (CN) 202011379108.8

(51) Int. Cl. H01M 10/42; H01M 10/48; H02J 7/00; H02M 3/335

(52) U.S. Cl. CPC H01M 10/4257; H01M 10/486; H02J 7/0014; H02J 7/00309; H02J 7/0048; H02J 7/005; H02J 7/0063; H02M 3/33573; H02M 3/33584; H01M 2010/4271

(57) ABSTRACT

Disclosed is a power electronic intelligent battery unit, including: a battery module, the battery module comprising a plurality of battery cells connected in series and sensors for measuring the voltage, current, pressure and/or temperature of the battery cells; and an intelligent battery interface, the intelligent battery interface being connected to an output side of the battery module and the sensors, and the intelligent battery interface having a power interface and an information interface for the outside, wherein the battery module monitors the voltage, current, pressure and/or temperature information of the battery cells, while providing or absorbing power by means of the intelligent battery interface.

### TECHNICAL FIELD

The present application relates to the technical field of battery energy storage, in particular, the present application relates to a safe, reliable, high-efficiency, flexible and extendible power electronic intelligent battery unit.

### BACKGROUND

With the continuous increase of installed capacity of new energy power generation and the continuous development of intelligent grids, the requirement for the capacity and functions of energy storage systems is increasing. Wherein, the battery energy storage system has the advantages of no moving parts, no special requirements for the site, easily extendible, and good dynamic characteristics, it is widely used in occasions such as power grid side frequency modulation and peak modulation, user side load emergency support, and smoothing of renewable energy power fluctuations.

A typical large-capacity battery system is composed of a large number of battery cells according to the method shown in FIG. 1, a single battery cell is connected in series and parallel to form a battery module, multiple battery modules form a battery rack, multiple battery racks further form a large-capacity battery system, the entire large-capacity battery system uses a single-stage PCS as a power interface to connect to the grid or load to realize bidirectional flow of power.

In addition to being used in large-capacity energy storage systems that support power grids, battery energy storage is also widely used in the field of household energy storage. FIG. 2 shows a typical household solar-storage complementary and off-grid integrated power conversion architecture. In this system, household photovoltaic cells and energy storage batteries form a good complementary and synergistic relationship. Wherein, a 48V battery module is connected to a 400V DC bus through an isolated bidirectional DC converter. Tesla has also launched an energy storage system for industrial and commercial applications, as shown in FIG. 3. A 48V low-voltage battery module passes through a 1.6 kW isolated bidirectional DC converter, which is equivalent to a PowerPod with an output voltage of 400V at the output of the DC converter, 16 sets of PowerPods are connected in parallel through the DC bus to form a 25 kW/4-hour Powerpack, and 10 sets of Powerpacks are connected in parallel to a 250 kW inverter to form a 250 kW/4-hour battery energy storage system.

Due to the low voltage and small capacity of a single battery cell, in various energy storage application scenes, it is necessary to connect a large number of battery cells in series and parallel. At the same time, in the production and manufacturing process of battery cells, it is difficult to ensure the consistency of the performance of each battery cell, after the battery cells are connected to the energy storage system and participate in the charging and discharging cycle, the working environment of each battery cell and the aging rate of each battery cell are also different, which also leads to further aggravation of the inconsistency of the battery cell performance. However, the inconsistency in the performance of battery cells makes it difficult to ensure the same state of charge of each battery in the same energy storage system. Since the open circuit voltage and internal impedance of the battery cell are closely related to the state of charge of the battery, when the state of charge of the battery cell is inconsistent, there will be a circulating current inside the battery module and between the battery modules connected in parallel due to the inconsistency of the battery voltage. The continuous existence of this circulating current will cause considerable loss in the internal resistance of the battery and the resistance of the line, which will significantly reduce the charge-discharge cycle efficiency of the battery energy storage system. At the same time, the existence of battery circulating current will also accelerate the aging of the battery, increasing the internal resistance of the battery, further increasing the loss of the energy storage system, reducing the overall life of the energy storage system, and increasing the system cost.

As mentioned above, due to the inconsistency of battery performance, the state of charge of each battery cell is inconsistent during the charging and discharging cycle of the energy storage system. For a series of battery cells connected in series, during the charging process, there will be a situation where a certain battery is fully charged and the rest of the battery is not fully charged, in order to avoid overcharging the battery, the rest of the battery will not be able to be fully charged; similarly, during the discharging process, there may be a situation where a certain battery has reached the minimum allowable state of charge, while the rest of the battery can still be further discharged, at this time, in order to avoid damage to the battery cells caused by over-discharge, all the battery cells connected in series will stop discharging. It can be seen that the inconsistency of the performance of the battery cells will lead to the limitation of the overall available capacity of the energy storage system, resulting in a waste of configuration capacity and increasing the cost of the energy storage system.

At the same time, the circulating current caused by the inconsistency of the battery will also accelerate the aging and damage of the battery, increasing the maintenance cost of the system. On the other hand, for a series of battery cells connected in series, when one of the battery cells is aged and damaged and cannot continue to be charged and discharged, all the battery cells connected in series will not work normally. Due to the large number of battery cells connected in series in a large-capacity and high-voltage energy storage system, this problem will also significantly increase the cost and efficiency of the battery energy storage system.

In order to solve the problem of inconsistent performance of battery cells, two methods, battery screening and battery balancing, are often used at present. The battery screening refers to testing the performance of each battery cell when the battery leaves the factory, and selecting battery cells with consistent performance to be connected in series and parallel to form a battery module. This process requires a lot of time and labor costs, at the same time, the percentage of batteries that can pass the screening and meet the requirements of the energy storage system is only about 60%, which makes the cost of battery manufacturing and screening very large.

The battery balancing is to make the state of charge of each battery cell always consistent through passive balancing or active balancing after the batteries form a string. The passive balancing consumes the power of the battery cells with a high state of charge on the resistor or diode, resulting in large losses and slow current sharing speed. The active balancing uses energy storage elements such as capacitors and inductors, and cooperates with the high-speed switching of the switch transistor to transfer the power from the battery cell with a high state of charge to the battery cell with a low state of charge. This method can effectively balance the battery cells, but the hardware cost is high and the control is complicated. In order to ensure the safe and reliable operation of the battery energy storage system, the battery balancing is an indispensable functional unit, which further increases the loss and cost of the battery energy storage system.

In a traditional battery energy storage system, there is only one overall battery management system (BMS) and one power conversion system (PCS), and each battery module is equipped with a battery monitoring unit (BMU). The battery monitoring unit has the functions of collecting battery voltage, current, and temperature information, and balancing the battery cells in the battery module. Since the battery module itself lacks power control capability, it can only be charged and discharged passively, so it is difficult to avoid overcharging and over-discharging. The overcharging and over-discharging of the battery will lead to a decrease in battery capacity and an increase in internal resistance, and at the same time cause irreversible structural damage inside the battery, furthermore, it will lead to the occurrence of short circuit in the battery, resulting in thermal runaway of the battery and serious accidents of the battery energy storage system.

At the same time, the battery monitoring unit in the battery module can only passively provide battery status information to the overall battery management system, and the battery management system also lacks an effective means of evaluating the battery fault state. For the structural damage of the battery, especially the potential internal short-circuit fault, the external characteristics such as voltage, current, and surface temperature of the battery will not change significantly in the initial stage, and it is difficult to be effectively and accurately identified by the battery monitoring unit. The further development of these damages and micro-faults will cause serious internal short-circuit faults and cause large-scale thermal runaway.

In the prior art, the following battery management and battery safety control methods have been proposed:

(1) The patent application No. CN111416399A proposes an intelligent battery and intelligent control module with active detection and control functions, which can realize an active detection and control function, and then replace the external control mechanism. However, because it cannot actively estimate the health status of the battery, this module cannot predict the fault information of the battery in advance and take measures in advance, and still cannot effectively avoid the serious consequences of the battery fault.

(2) The patent application No. CN103944225A proposes a battery intelligent management method and battery intelligent management device, which can maintain the best working condition of the battery and prolong the service life of the battery, but also cannot guarantee the safe operation of the battery.

### SUMMARY

According to one aspect of the present invention, a power electronic intelligent battery unit is provided, comprising:
a battery module, the battery module comprising a plurality of battery cells connected in series and a sensor for measuring voltage, current, pressure and/or temperature of the battery cell; and
an intelligent battery interface, connected to the output side of the battery module and the sensor, and having a power interface and an information interface to the outside,
wherein the battery module monitors the voltage, current, pressure and/or temperature information of the battery cell, and at the same time provides or absorbs power through the intelligent battery interface.

In one embodiment of the present invention, the intelligent battery interface transmits status information and fault information through the information interface, and receives control information from the information interface, the intelligent battery interface changes its DC voltage gain according to the voltage of
the battery output side of the connected battery module to maintain the voltage stability of the power interface of the power electronic intelligent battery unit.

In one embodiment of the present invention, the sensor comprises one or more of the following items:
a plurality of voltage sensors, temperature sensors and pressure sensors arranged on the battery cells of the battery module, to detect the cell voltage, temperature and pressure data of the battery module;
a plurality of voltage sensors and current sensors arranged within the battery module, to detect the voltage and current data of the output side of the battery module.

In one embodiment of the present invention, the intelligent battery interface comprises:
a processor;
a conditioning circuit connected to the output end of the sensor, and conditioning the electrical signal output by the sensor to form an electrical signal that can be read by the processor;
a power converter connected to the battery module, enabling bidirectional flow and active control of power according to the control of the processor, and forming a stable and controllable output voltage at the power interface; and
a balance circuit arranged at both ends of each battery cell, and realizing the balance of the state of charge of the battery cells by switching the switch transistor, through a certain balance algorithm, under the control of the processor.

In one embodiment of the present invention, the power converter is a bidirectional isolated DC converter, and the bidirectional isolated DC converter has different voltage gain expressions when operating forward and reverse.

In one embodiment of the present invention, the power converter comprises:
a first AC-DC conversion circuit, including a first full bridge circuit composed of first to fourth switch transistors;
a second AC-DC conversion circuit, including a second full bridge circuit composed of fifth to eighth switch transistors; and
an isolated bidirectional resonant network, including a first inductor, a transformer, a first AC port on the primary side of the transformer, and a second AC port on the secondary side of the transformer,
wherein the midpoints of the two bridge arms of the first full bridge circuit are respectively connected to the first AC end and the second AC end of the first AC port of the isolated bidirectional resonant network, and the midpoints of the two bridge arms of the second full bridge circuit are respectively connected to the first AC end and the second AC end of the second AC port of the isolated bidirectional resonant network.

In one embodiment of the present invention, the isolated bidirectional resonant network further comprises a second inductor, a first capacitor, a second capacitor, and an auxiliary capacitor, the first inductor and the first capacitor are connected in series, one end of the first inductor is connected to the first AC end of the first AC port, one end of the first capacitor is connected to the first AC end of the primary side of the transformer, the second AC end of the primary side of the transformer is connected to the second AC end of the first AC port, the first AC end of the secondary side of the transformer is connected to one end of the second capacitor, the other end of the second capacitor is connected to one end of the second inductor, the other end of the second inductor is connected to the first AC end of the second AC port, the second AC end of the secondary side of the transformer is connected to the second AC end of the second AC port; a tap is drawn from the middle of the winding on the primary side of the transformer, and the auxiliary capacitor is connected between the tap and the second AC end of the primary side of the transformer.

In one embodiment of the present invention, the isolated bidirectional resonant network further comprises a first capacitor and an auxiliary capacitor, the first inductor and the first capacitor are connected in series, one end of the first inductor is connected to the first AC end of the first AC port, one end of the first capacitor is connected to the first AC end of the primary side of the transformer, the second AC end of the primary side of the transformer is connected to the second AC end of the first AC port, the two ports on the secondary side of the transformer are connected to the two ports of the second AC port, a tap is drawn from the middle of the winding on the primary side of the transformer, and an auxiliary capacitor is connected between the tap and the second AC end of the primary side of the transformer.

In one embodiment of the present invention, the power converter is a bidirectional non-isolated DC converter, including first to fourth switch transistors, an inductor, a first capacitor and a second capacitor, the first switch transistor and the second switch transistor are connected in series to form a half bridge, and the first capacitor is connected in parallel; the third switch transistor and the fourth switch transistor are connected in series to form a half bridge, and the second capacitor is connected in parallel, and the sources of the second switch transistor and the fourth switch transistor are connected; the inductor is connected with the midpoints of the arms of the two half bridges.

In one embodiment of the present invention, the intelligent battery interface further comprises:
a protection device installed at/on the connection end of the intelligent battery interface and the power interface;
a cooling device installed on the power converter and the battery module to absorb the heat generated by the two and increase the heat dissipation area, while the cooling device has a unified structure, to transfer the additional heat generated by the power converter to the battery module, when the ambient temperature is too low, to prevent the battery module from being damaged due to low temperature.

In one embodiment of the present invention, the power converter further comprises an auxiliary power supply that provides power for the processor, the driving circuit of the power converter, the protection device, the cooling device and the balance circuit.

In one embodiment of the present invention, the processor is configured to perform one or more of the following operations:
identifying and calibrating the parameter model of the battery module by measuring, collecting and recording battery voltage, current, pressure and temperature information, and using a variety of parameter identification methods;
estimating and recording the state of charge of the battery by measuring, collecting and recording the battery voltage, current, pressure and temperature information, synthesizing the parameter model of the battery module, and using a variety of charge state estimation methods;
estimating the battery health state by measuring, collecting and recording the battery voltage, current, pressure and temperature information, combining the battery state of charge information, and synthesizing a variety of battery health state estimation models;
updating the current equivalent circuit model of the battery module through the estimated battery state of charge and battery health state, and correcting the controller parameters for battery charge and discharge power conversion;
estimating the energy currently stored in the battery and the power boundary of the current charge and discharge of the battery through the estimated battery state of charge and battery health state, and controlling the power of battery charge and discharge;
uploading status information, such as voltage, current, temperature, pressure, etc. of a large number of battery modules, as well as historical charge and discharge cycle records, and fault records, to the online computing platform, through data mining and model training, analyzing the state trace of the battery within a certain period of time before the occurrence of different faults, extracting the characteristic parameters for judging the probability of different faults, and establishing a mathematical model of the characteristic parameters and the probability of fault, establishing a mathematical model to calculate the overall reliability of the intelligent battery unit, and sending the model to each intelligent battery unit through the data bus.
evaluating the historical working trajectory of the battery, analyzing the potential faults, predicting the current health status of the battery, predicting possible faults and fault types, and giving fault prediction information;
calculating the current reliability of the battery module by using the state information, such as its own voltage, current, temperature, pressure, etc., historical charge and discharge cycle records, according to the fault prediction model and reliability model, and actively warning and reducing operation power for intelligent battery units whose reliability is lower than the requirement;
determining whether the battery breaks down at the moment by using the state information, such as its own voltage, current, temperature, pressure, etc., historical charge and discharge cycle records, according to the fault prediction model; when determining that the battery breaks down, taking the module out of the operating state, and taking active cooling measures to avoid thermal runaway of the module, and sending fault information through the communication interface;
comparing the voltage on the output side of the battery module obtained by the voltage sensor with the voltage on the power interface of the power electronic intelligent battery module, when the power of the battery module decreases as the battery discharges and the voltage at the output side of the battery module decreases, increasing the DC voltage gain to keep the voltage of the power interface unchanged; when the power of the battery module increases with battery charging and the voltage at the output side of the battery module rises, reducing the DC voltage gain to keep the voltage of the power interface unchanged;
monitoring the power transmitted by the intelligent battery interface by the voltage sensor and the current sensor, and changing the magnitude and direction of the output current of the battery module, so that the magnitude and direction of the output power of the power electronic intelligent battery module meet the set requirements.

In one embodiment of the present invention, the intelligent battery interface is connected to an online computing platform, the online computing platform collects parameters and state traces of a large number of power electronic intelligent battery modules during repeated cycle operation through remote communication with a large number of power electronic intelligent battery modules, and through big data mining and intelligent algorithms, corrects and optimizes the parameter models, state estimation algorithms, fault prediction algorithms, and charge and discharge control algorithms of batteries in different working environments, and periodically sends the results to each intelligent battery module.

According to another embodiment of the present invention, an intelligent battery interface connected to the output side of the battery module and the sensor, and connected to the power interface and the information interaction interface is provided, comprising:
a processor;
a conditioning circuit connected to the output end of the sensor, and conditioning the electrical signal output by the sensor to form an electrical signal that can be read by the processor;
a power converter connected to the battery module, enabling bidirectional flow and active control of power according to the control of the processor, and forming a stable and controllable output voltage at the power interface; and
a balance circuit arranged at both ends of each battery cell, the balance circuit realizing the balance of the state of charge of the battery cells by switching the switch transistor, through a certain balance algorithm, under the control of the processor.

In another embodiment of the present invention, the intelligent battery interface further comprises:
a protection device installed at the connection end of the intelligent battery interface and the power interface;
a cooling device installed on the power converter and the battery module to absorb the heat generated by the two and increase the heat dissipation area, while the cooling device has a unified structure, to transfer the additional heat generated by the power converter to the battery module, when the ambient temperature is too low, to prevent the battery module from being damaged due to low temperature.

In another embodiment of the present invention, the intelligent battery interface further comprises an auxiliary power supply providing power for the processor, the driving circuit of the power converter, the protection device, the cooling device and the balance circuit.

According to still another embodiment of the present invention, a battery system composed of the power electronic intelligent battery unit is provided, comprising:
a plurality of the power electronic intelligent battery units, a DC bus and a communication bus,
wherein the power interfaces of the plurality of power electronic intelligent battery units are connected to the DC bus in parallel, or the power interfaces of the plurality of power electronics intelligent battery units are connected in series and then connected to the DC bus;
the information interaction interfaces of the plurality of power electronic intelligent battery units are connected to the communication bus, upload the status information and fault information of each battery, receive control commands for the power electronic intelligent battery units, and control the plunge-in and switch-out of the battery unit, and the size and direction of the transmitted power.

In still another embodiment of the present invention, the power of each power electronic intelligent battery unit is determined based on the battery status information provided by a plurality of the power electronic intelligent battery units, and the control strategy for each unit is determined in combination with the power interface control method of the power electronic intelligent battery unit.

In still another embodiment of the present invention, when a battery unit among the plurality of power electronic intelligent battery units breaks down, its fault information is first detected and acquired by its own battery state monitoring unit, and its own intelligent battery interface performs the active fault isolation of the faulty battery unit;
the faulty power electronic intelligent battery unit uploads the battery fault information to the communication bus through the information interaction interface;
the power of the power electronic intelligent battery units that do not break down is redistributed, and the control command it receives controls the magnitude and direction of the transmission power of the battery units.

### BRIEF DESCRIPTION OF THE DRAWINGS

In order to further clarify the above and other advantages and features of various embodiments of the present invention, a more particular description of various embodiments of the present invention will be presented with reference to the accompanying drawings. It is understood that the drawings depict only typical embodiments of the invention and therefore are not to be considered limiting of its scope. In the drawings, the same or corresponding parts will be denoted by the same or similar symbols for clarity.

FIG. 1 shows the composition manner of a large-capacity battery system in the prior art.

FIG. 2 shows a typical household solar-storage complementary and off-grid integrated power conversion architecture.

FIG. 3 shows a schematic diagram of an energy storage system based on a high-frequency DC-DC converter.

FIG. 4 shows the process of battery recovery and detection in steps.

FIG. 5 shows a schematic block diagram of an electronic intelligent battery unit according to an embodiment of the present invention.

FIG. 6 shows a schematic block diagram of an intelligent battery interface according to an embodiment of the present invention.

FIG. 7 shows a schematic diagram of a hardware structure of an electronic intelligent battery unit according to an embodiment of the present invention.

FIG. 8 shows a schematic circuit diagram of a conditioning circuit according to an embodiment of the present invention.

FIG. 9 shows a schematic circuit diagram of a bidirectional isolated DC converter according to an embodiment of the present invention.

FIG. 10 shows a schematic circuit diagram of a bidirectional isolated DC converter according to another embodiment of the present invention.

FIG. 11 shows a schematic circuit diagram of a bidirectional isolated DC converter according to still another embodiment of the present invention.

FIG. 12 shows a schematic circuit diagram of a bidirectional non-isolated DC converter according to an embodiment of the present invention.

FIG. 13 shows a schematic circuit diagram of a balance circuit according to an embodiment of the present invention.

FIG. 14 shows an overall flow diagram of a battery module according to an embodiment of the present invention.

FIG. 15 shows a flowchart of parameter identification according to one embodiment of the present invention.

FIG. 16 shows a flowchart of state of charge estimation according to an embodiment of the present invention.

FIG. 17 shows a flow diagram of the online platform according to one embodiment of the present invention.

FIG. 18 shows a schematic diagram of a parallel expansion system 800 based on the power electronic intelligent battery unit according to an embodiment of the present invention.

FIG. 19 shows a schematic diagram of a series expansion system 900 based on the power electronic intelligent battery unit according to an embodiment of the present invention.

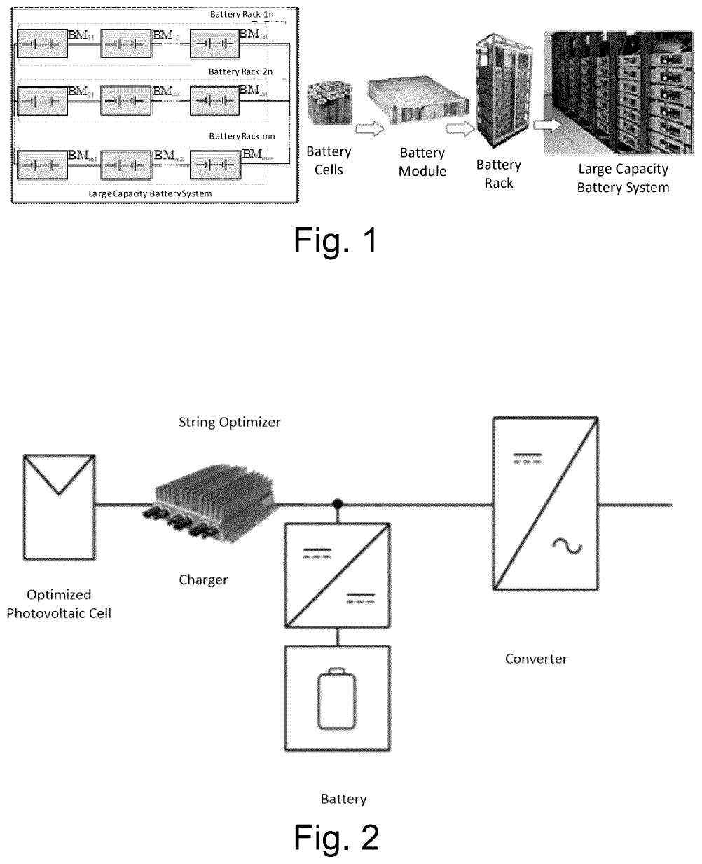

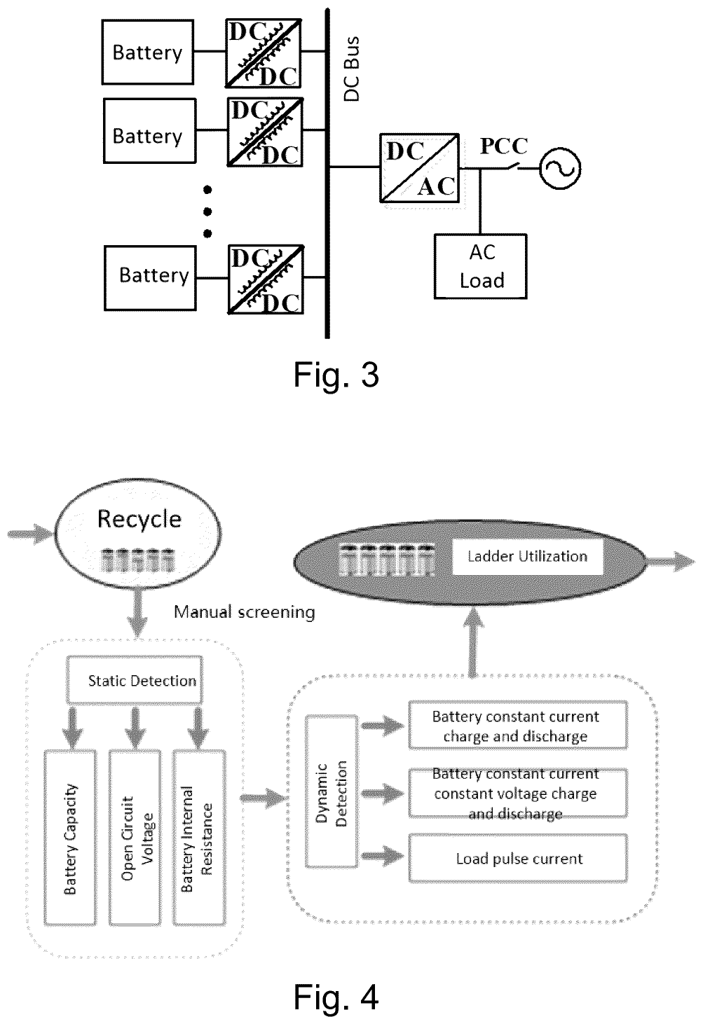

### DESCRIPTION OF THE EMBODIMENTS

In the following description, the present invention is described with reference to various examples. However, the skilled in the art will recognize that the various embodiments may be practiced without one or more of the specific details, or with other alternative and/or additional methods, materials, or components. In other instances, well-known structures, materials, or operations are not shown or described in detail so as not to obscure aspects of the various embodiments of the invention. Similarly, for purposes of explanation, specific quantities, materials and configurations are set forth in order to provide a thorough understanding of embodiments of the invention. However, the invention may be practiced without these specific details. Furthermore, it should be understood that the various embodiments shown in the drawings are illustrative representations and are not necessarily drawn to scale.

In the description, reference to “one embodiment” or “the embodiment” means that a particular feature, structure, or characteristic described in connection with the embodiment is included in at least one embodiment of the present invention. The appearances of the phrase “in one embodiment” in various places in the description are not necessarily all referring to the same embodiment.

As to the problems existing in the prior art, the present application provides a safe, reliable, high-efficiency, flexible and extendible power electronic intelligent battery unit, which can realize the safe, reliable and high-efficiency operation of the battery module, and can realize flexible plug-in and combination expansion of multiple battery modules. The power electronic intelligent battery unit is composed of two parts: the intelligent battery interface and the battery module. The battery module part is similar to the traditional battery energy storage system, which consists of multiple battery cells connected in series and parallel to form a battery module with a certain voltage and capacity. The intelligent battery interface integrates the functions of the battery management system and power conversion, and can detect and record the voltage, temperature, and pressure of each battery cell in the battery module, as well as the input and output current of the entire battery module, and use the collected battery status information to conduct online identification and estimation of the battery's internal parameters, state of charge, and state of health. At the same time, it has various communication interfaces to realize information interaction with the outside. At the same time, the intelligent battery interface also integrates the function of bidirectional power exchange, providing stable and controllable input and output current, port voltage and dynamic response characteristics at the external port. At the same time, the packaging and heat dissipation management of the intelligent battery interface and the battery module are performed in a unified manner, and externally appear as a unified power electronic intelligent battery unit, and has an information interaction interface and a power conversion interface.

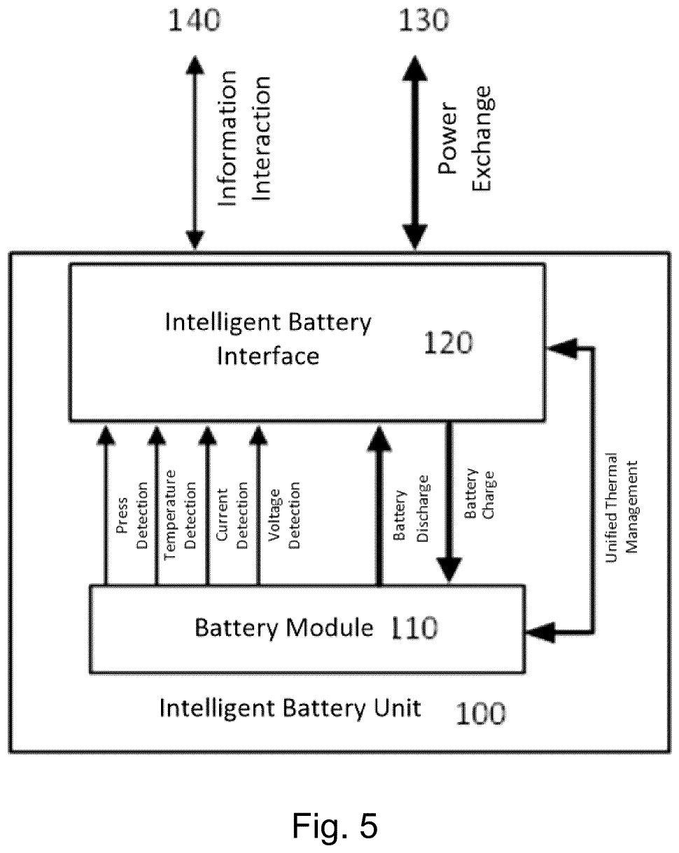

FIG. 5 shows a schematic block diagram of an electronic intelligent battery unit according to an embodiment of the present invention.

Please refer to FIG. 5, the power electronic intelligent battery unit 100 of this embodiment comprises a battery module 110 and an intelligent battery interface 120. The battery module 110 may be composed of several battery cells connected in series, and has an energy storage function. One end of the intelligent battery interface 120 is connected to the output side of the battery module 110 and the sensors of several battery cells in the battery module 110. The other end of the intelligent battery interface 120 is connected to the power interface 130 and the information interaction interface 140 of the intelligent battery unit 100. The intelligent battery interface 120 has functions of battery state monitoring, battery state estimation, battery safety management, and battery charging and discharging power conversion.

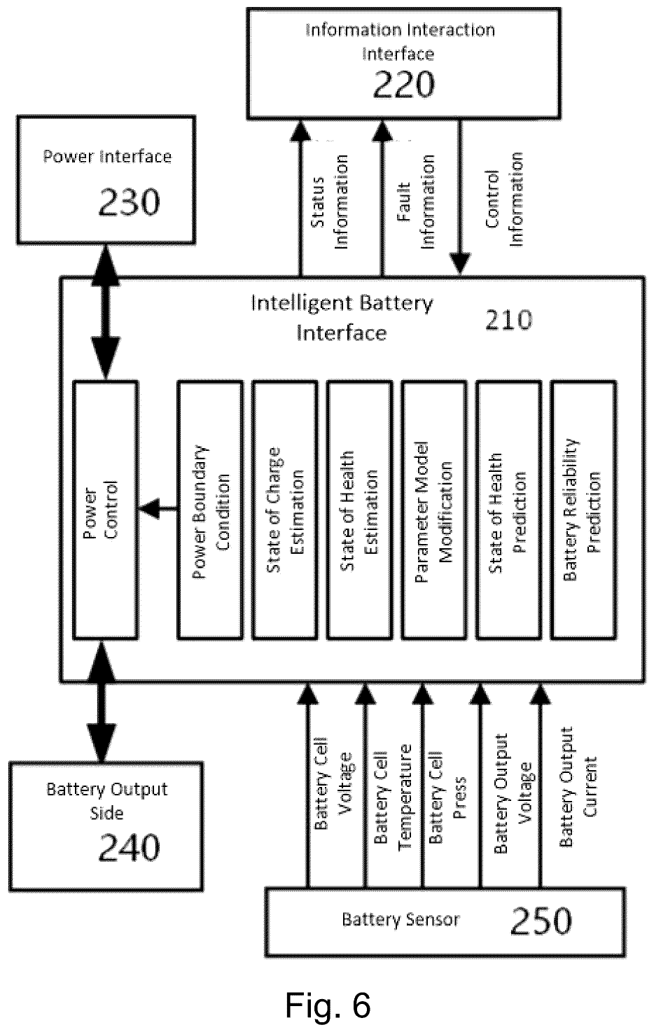

FIG. 6 shows a schematic block diagram of an intelligent battery interface according to an embodiment of the present invention.

Please refer to FIG. 6, the intelligent battery interface of this embodiment is applied to the power electronic intelligent battery unit in FIG. 1. This intelligent battery interface estimates the working status of the battery module, predicts the health status and reliability of the battery module, sets the power boundary conditions for charging and discharging the battery, monitors the fault of the battery module, and exchanges battery status information through the information interaction interface of the intelligent battery unit, by monitoring the voltage, current, pressure and temperature information of the battery module and each battery cell in the battery module.

As shown in FIG. 6, the functions of the intelligent battery interface 210 may include battery reliability prediction, state of health prediction, parameter model modification, state of health estimation, state of charge estimation, power boundary conditions, power control, and so on.

The intelligent battery interface 210 is connected with the information interaction interface 220, transmits status information and fault information to the information interaction interface 220, and receives control information from the information interaction interface 220.

The intelligent battery interface 210 is connected with the power interface 230, changes its own DC voltage gain according to the voltage of the battery output side 240 of the connected battery module, to maintain the voltage stability of the power interface 230 of the power electronic intelligent battery unit.

The intelligent battery interface 210 is connected with the battery sensor 250 arranged on the battery module. The battery sensor 250 may include a plurality of voltage sensors, temperature sensors, pressure sensors, and the like. The intelligent battery interface 210 detects the cell voltage, temperature and pressure data of the battery module through a plurality of voltage sensors, temperature sensors and pressure sensors arranged on the battery cells of the battery module, and detects the voltage and current data on the output side of the battery module through a plurality of voltage sensors and current sensors arranged in the battery module.

The intelligent battery interface 210 identifies and calibrates the parameter model of the battery module by measuring, collecting and recording battery voltage, current, pressure and temperature information, and using a variety of parameter identification methods;

The intelligent battery interface 210 estimates and records the state of charge of the battery by measuring, collecting and recording the battery voltage, current, pressure and temperature information, synthesizing the parameter model of the battery module, and using a variety of charge state estimation methods;

The intelligent battery interface 210 estimates the battery health state by measuring, collecting and recording the battery voltage, current, pressure and temperature information, combining the battery state of charge information, and synthesizing a variety of battery health state estimation models;

The intelligent battery interface 210 updates the current equivalent circuit model of the battery module through the estimated battery state of charge and battery health state, and corrects the controller parameters for battery charge and discharge power conversion;

The intelligent battery interface 210 estimates the energy currently stored in the battery and the power boundary conditions of the current charge and discharge of the battery through the estimated battery state of charge and battery health state, and controls the power of battery charge and discharge;

The intelligent battery interface 210 uses status information, such as voltage, current, temperature, pressure, etc. of a large number of battery modules, as well as historical charge and discharge cycle records, and fault records, analyzes the state trace of the battery within a certain period of time before the occurrence of different faults through data mining and model training, extracts the characteristic parameters for determining the probability of different faults, and establishes a mathematical model of the characteristic parameters and the probability of fault, establishes a mathematical model to calculate the overall reliability of the intelligent battery unit, and sends the model to each intelligent battery unit through the data bus.

The intelligent battery interface 210 evaluates the historical working trajectory of the battery, analyzes the potential faults, predicts the current health status of the battery, predicts possible faults and fault types, and gives fault prediction information;

The intelligent battery interface 210 calculates the current reliability of the battery module by using the state information, such as its own voltage, current, temperature, pressure and so on, historical charge and discharge cycle records, according to the fault prediction model and reliability model, and actively warns and reduces the power upper limit for intelligent battery units whose reliability is lower than the requirement;

The intelligent battery interface 210 determines whether the battery breaks down by using the state information, such as its own voltage, current, temperature, pressure and so on, historical charge and discharge cycle records, according to the fault prediction model; when determining that the battery module breaks down, takes the module out of the operating state, and takes active cooling measures to avoid thermal runaway of the module, and sends fault information through the communication interface;

The intelligent battery interface 210 collects the voltage on the output side of the battery module obtained by the voltage sensor and the voltage on the power interface of the power electronic intelligent battery module, when the power of the battery module decreases as the battery discharges and the voltage at the output side of the battery module decreases, increases the DC voltage gain to keep the voltage of the power interface unchanged; when the power of the battery module increases with battery charging and the voltage at the output side of the battery module rises, reduces the DC voltage gain to keep the voltage of the power interface unchanged;

The intelligent battery interface 210 monitors the power transmitted by the intelligent battery interface by the voltage sensor and the current sensor, and changes the magnitude and direction of the output current of the battery module, so that the magnitude and direction of the output power of the power electronic intelligent battery module meet the set requirements.

The intelligent battery interface 210 implements fault cooperative protection of the battery module and the intelligent battery interface through fault diagnosis; when the intelligent battery interface judges that the battery module has an over-current and/or high temperature fault, it sends a fault signal, reduces power at the same time, and eliminates the fault state; when the intelligent battery interface judges that one or more of the short-circuit fault, over-voltage fault, under-voltage fault, and battery internal over-voltage fault occurs, it sends a fault signal and disconnects the power interface of the power electronic intelligent battery unit at the same time, to take the battery module out of operation, isolate the fault in time, and avoid accidents.

The intelligent battery interface 210 has a battery over-voltage monitoring function and a battery under-voltage monitoring function. When it detects that the output side voltage of the battery module and the cell voltage of each battery module are higher than the allowable maximum value, the intelligent battery interface judges it as a battery over-voltage fault, and sends out a battery over-voltage fault signal; when it detects that the output side voltage of the battery module and the cell voltage of each battery module are lower than the allowable minimum value, the intelligent battery interface judges it as a battery under-voltage fault, and sends out a battery under-voltage fault signal.

The intelligent battery interface 210 has a battery over-current monitoring function. When detecting that the current at the output side of the battery module is higher than the allowable maximum value, the intelligent battery interface judges it as a battery over-current fault and sends out a battery over-current fault signal.

The intelligent battery interface 210 has a battery temperature monitoring function. When detecting that the battery temperature is higher than the allowable maximum value, the intelligent battery interface judges that the battery temperature is too high, and sends out a battery high temperature fault signal; when the battery core temperature detected by the temperature sensor is lower than the allowable minimum value, the intelligent battery interface judges that the battery temperature is too low, and sends out a battery low temperature fault signal.

The intelligent battery interface 210 has a battery short-circuit monitoring function. When the cell voltage of the battery module detected by the voltage sensor is lower than the short-circuit fault threshold, the intelligent battery interface judges that the cell of the battery module is short-circuited internally, and sends out a battery internal short-circuit fault signal.

The intelligent interface 210 has a battery pressure monitoring function, when the battery internal pressure detected by the battery pressure sensor is higher than the allowable value, the module judges that the battery internal pressure is too high and sends out a battery internal over-voltage fault signal.

The intelligent battery interface and battery module implement a unified heat management strategy: the battery module in the power electronic intelligent battery module has performance defects due to low ambient temperature, and the low temperature state is detected and obtained by the battery information monitoring unit; the intelligent battery interface reduces the efficiency of power conversion by controlling the power converter, resulting in more loss and heat; the intelligent battery interface and the battery module have a unified heat dissipation package, the heat generated by the intelligent battery interface makes the temperature of the battery module rise and maintain a relatively stable temperature through the unified heat dissipation structure, ensuring the reliable operation of the battery module.

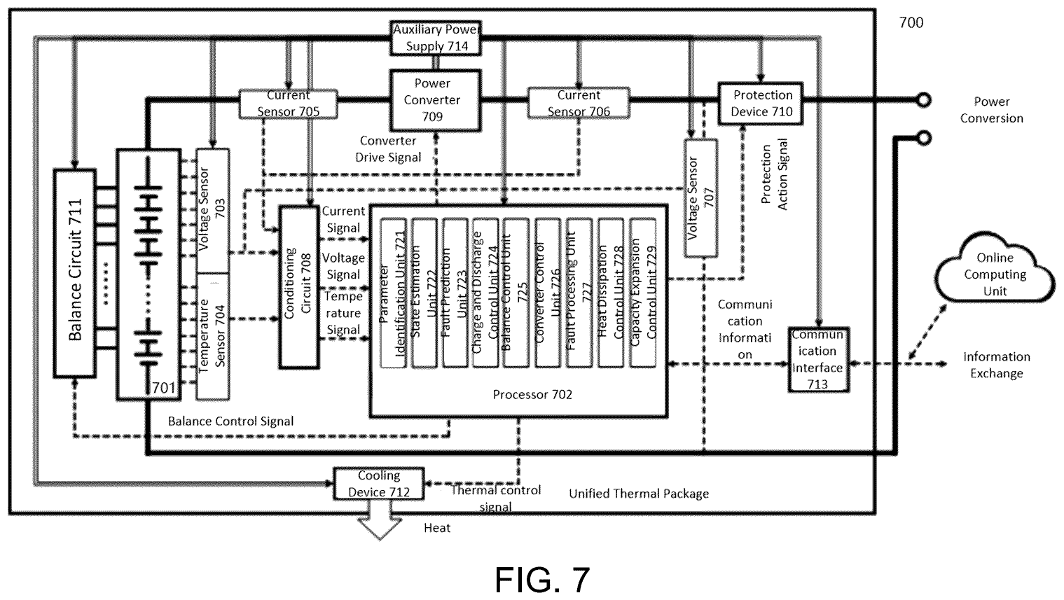

FIG. 7 shows a schematic diagram of a hardware structure of an electronic intelligent battery unit according to an embodiment of the present invention.

The power electronic intelligent battery unit 700 may include a battery module 701, a processor 702, various sensors 703-707, a conditioning circuit 708, a power converter 709, a protection device 710, a balance circuit 711, a cooling device 712 and a communication interface 713.

The battery module 701 is composed of multiple battery cells connected in series and parallel, which is the hardware basis of the power electronic intelligent battery unit.

The processor 702 may realize functions such as analog-to-digital conversion, calculation, and control, be connected to the conditioning circuit 708, output control signals to the power converter 709, the protection device 710, the balance circuit 711, and the cooling device 712, and perform data interaction with the communication interface 713.

The sensors may include voltage sensors, current sensors, temperature sensors, pressure sensors, and the like. The voltage sensor 703 is arranged at both ends of each battery cell. The voltage sensor 707 is arranged at both ends of the entire battery module for collecting voltage signals. The current sensor 705 and 706 are arranged on the strings formed by each battery cell and at both ends of the power converter for collecting current signals. The temperature sensor 704 and the pressure sensor (not shown) are arranged around the battery module for collecting temperature and pressure signals at various positions of the battery module, at the same time, temperature sensors (not shown) are also arranged at key positions of the power converter and the cooling device for collecting temperature signals of the power converter and the cooling device. Those skilled in the art should understand that the figure only schematically shows an example of multiple sensors, which is only used to explain the present invention rather than limit the present invention, and the electronic intelligent battery unit of the present invention may include more or fewer sensors, and the number and arrangement of the sensors are not limited to the examples shown.

The conditioning circuit 708 is connected to the output ends of the above-mentioned sensors, and conditions the electrical signals output by the above-mentioned sensors to form electrical signals that can be read by the processor.

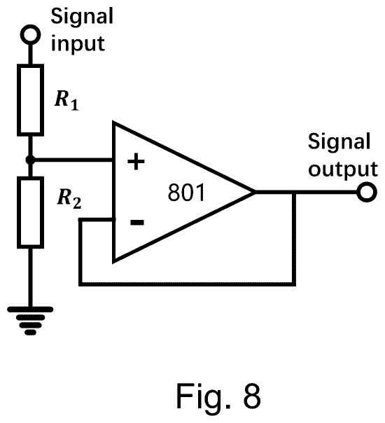

FIG. 8 shows a schematic circuit diagram of a conditioning circuit according to an embodiment of the present invention. As shown in FIG. 8, the conditioning circuit may include a first resistor R1, a second resistor R2 and a comparator 801. The signal input end of the conditioning circuit is connected to one end of the first resistor R1, the other end of the first resistor R1 is connected to one end of the second resistor R2 and the non-inverting input end of the comparator 801, the other end of the second resistor R2 is grounded, and the inverting input end of the comparator 801 is connected to the signal output end.

Returning to FIG. 7, the power converter 709 is connected to both ends of the battery module. In an embodiment of the present invention, the power converter 709 may adopt a bidirectional DC converter to realize bidirectional flow and active control of power, and form a stable and controllable output voltage and dynamic characteristics at the external port of the power electronic intelligent battery unit.

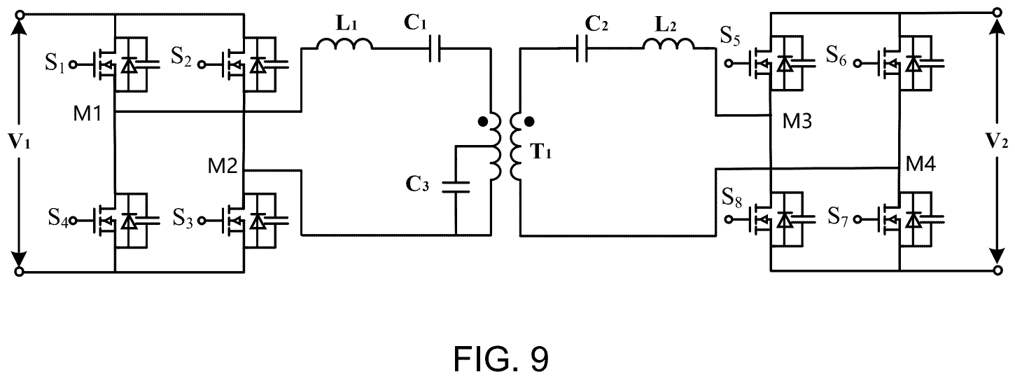

The power converter 709 described in the present invention may be realized by using a bidirectional isolated DC converter. FIG. 9 shows a schematic circuit diagram of a bidirectional isolated DC converter according to an embodiment of the present invention. This power converter includes a first AC-DC conversion circuit, a second AC-DC conversion circuit and an isolated bidirectional resonant network. The first AC-DC conversion circuit includes a full bridge circuit composed of first to fourth switch transistors S1, S2, S3, S4; The first to fourth switch transistors S1, S2, S3, and S4 may be MOS transistors. The first to fourth switch transistors S1, S2, S3, S4 respectively have a control end, a first end and a second end. The first end of the first switch transistor S1 and the second switch transistor S2 are connected with each other and connected to the first end of the DC port of the first AC-DC conversion circuit. The second end of the first switch transistor S1 is connected to the first end of the fourth switch transistor S4, and the connection node M1 serves as the midpoint of the first bridge arm. The second end of the second switch transistor S2 is connected to the first end of the third switch transistor S3, and the connection node M2 serves as the midpoint of the second bridge arm. The second end of the third switch transistor S3 and the fourth switch transistor S4 are connected with each other and connected to the second end of the DC port of the first AC-DC conversion circuit. The midpoints M1 and M2 of the two bridge arms of the full bridge circuit are respectively connected to the first AC end and the second AC end of the first AC port of the isolated bidirectional resonant network.

The second AC-DC conversion circuit includes a full bridge circuit composed of fifth to eighth switch transistors S5, S6, S7, S8. The fifth to eighth switch transistors S5, S6, S7, S8 may be MOS transistors. The fifth to eighth switch transistors S5, S6, S7, S8 respectively have a control end, a first end and a second end. The first end of the fifth switch transistor S5 and the sixth switch transistor S6 are connected with each other and connected to the first end of the DC port of the second AC-DC conversion circuit. The second end of the fifth switch transistor S5 is connected to the first end of the eighth switch transistor S8, and the connection node M3 serves as the midpoint of the third bridge arm. The second end of the sixth switch transistor S6 is connected to the first end of the seventh switch transistor S7, and the connection node M4 serves as the midpoint of the fourth bridge arm. The second end of the seventh switch transistor S7 and the eighth switch transistor S8 are connected with each other and connected to the second end of the DC port of the second AC-DC conversion circuit. The midpoints M3 and M4 of the two bridge arms of the full bridge circuit are respectively connected to the first AC end and the second AC end of the second AC port of the isolated bidirectional resonant network. The isolated bidirectional resonant network includes: a first inductor L₁, a second inductor L₂, a first capacitor C₁, a second capacitor C₂, an auxiliary capacitor C₃, a first AC port, a second AC port and a transformer T₁, the first inductor L₁ and the first capacitor C₁ are connected in series, one end of the first inductor L₁ is connected to the first AC end of the first AC port, one end of the first capacitor C₁ is connected to the first AC end of the primary side of the transformer T₁, the second AC end of the primary side of the transformer T₁ is connected to the second AC end of the first AC port, the first AC end of the secondary side of the transformer T₁ is connected to one end of the second capacitor C₂, and the other end of the second capacitor C₂ is connected to one end of the second inductor L₂, the other end of the second inductor L₂ is connected to the first AC end of the second AC port, and the second AC end of the secondary side of the transformer T₁ is connected to the second AC end of the second AC port; a tap is drawn from the middle of the primary winding of the transformer T₁, and an auxiliary capacitor C₃ is connected between the tap and the second AC end of the primary side of the transformer T₁, the excitation inductance of the transformer T₁ is divided into two excitation inductances by the tap: the first excitation inductance Lₘ₁ and the second excitation inductance Lₘ₂, the second excitation inductance Lₘ₂ and the auxiliary capacitor C₃ are connected in parallel and then connected in series with the first excitation inductance Lₘ₁ to form an equivalent excitation branch.

In one embodiment of the present invention, the bidirectional isolated DC converter has different voltage gain expressions when operating forward and reverse. In one embodiment of the present invention, the voltage gain expression when the bidirectional isolated DC converter operates in the forward direction is:

$${G}_{b} ( {f}_{n} ) = \frac{{V}_{2}}{{V}_{1}} = \frac{1}{n \sqrt{\begin{matrix}{( 1 + \frac{1}{k} - \frac{1}{{kf}_{n}^{2}} )}^{2} + {Q}^{2} [ ( 1 + h + \frac{h}{k} ) {f}_{n} - \\ {( 1 + \frac{1}{g} + \frac{h}{k} + \frac{1}{gk} ) \frac{1}{{f}_{n}} + \frac{1}{{kgf}_{n}^{3}} ]}^{2}\end{matrix}}}$$

$$k = \frac{1}{{k}_{1} + \frac{{k}_{2}}{1 - {m}^{2} {f}_{n}^{2}}}$$

Wherein, V₁ is the DC port voltage of the first AC-DC conversion circuit, V₂ is the DC port voltage of the second AC-DC conversion circuit, fₙ=f_{S}/f₁, f_{S} is the operating frequency, m=f₁/f₂, f₁ is the series resonance frequency of the first inductor and the first capacitor, f₂ is the parallel resonance frequency of the second excitation inductance and the auxiliary capacitor, f₁=1/2π\sqrt{L₁C₁}, f₂=1/2π\sqrt{Lₘ₂C₃}, Q=\sqrt{L₁/C₁}/(n²R₁), h=n²L₂/L₁, g=C₂/(n²C₁), k₁=Lₘ₁/L₁, k₂=Lₘ₂/L₁, fₙ is the normalized frequency, R₁ is the forward load, and n is the primary-to-secondary turns ratio of the transformer.

In one embodiment of the present invention, the voltage gain expression when the bidirectional isolated DC converter operates in the reverse direction is:

$${G}_{b} ( {f}_{n} ) = \frac{{V}_{1}}{{V}_{2}} = \frac{n}{\sqrt{{( 1 + \frac{1}{k} - \frac{1}{{kf}_{n}^{2}} )}^{2} + {{Q}^{2} [ ( 1 + h + \frac{h}{k} ) {f}_{n} - ( 1 + \frac{1}{g} + \frac{h}{k} + \frac{1}{gk} ) \frac{1}{{f}_{n}} + \frac{1}{{kgf}_{n}^{3}} ]}^{2}}}$$

$$k = \frac{1}{{k}_{1} + \frac{{k}_{2}}{1 - {m}^{2} {f}_{n}^{2}}}$$

Wherein, f₁=1/2π\sqrt{L₂C₂}, f₂=1/2π\sqrt{Lₘ₂C₃}, fₙ=f_{S}/f₁, m=f₁/f₂, f₁ is the series resonance frequency of the second inductor and the second capacitor, f₂ is the parallel resonance frequency of the second excitation inductance and the auxiliary capacitor, Q=n²\sqrt{L₂/C₂}/R₂, h=L₁/(n²L₂), g=n²C₁/C₂, k₁=Lₘ₁/L₂, k₂=Lₘ₂/L₂, fₙ is the normalized frequency, and R₂ is the reverse load.

According to the above voltage gain expression, when the parameters of the converter components are determined, by changing the switch frequency of the first and second AC-DC conversion circuits, the voltage gain of the bidirectional isolated DC converter can be changed, so that the voltage of the power interface of the power electronic intelligent battery unit is kept stable when the battery module port voltage changes due to the state of charge of the battery.

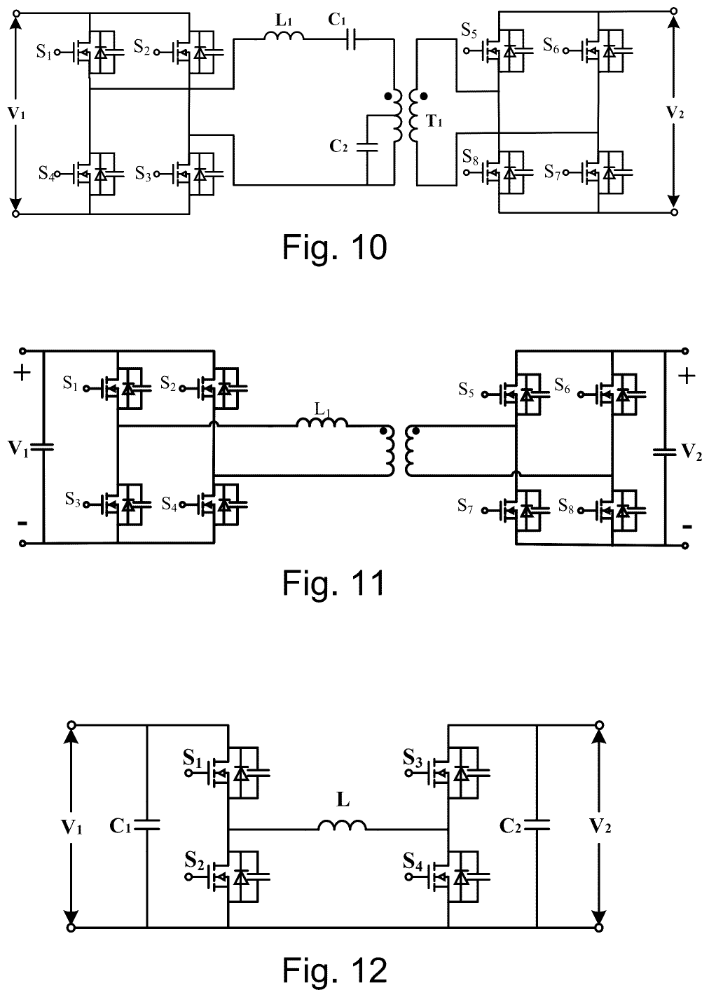

FIG. 10 shows a schematic circuit diagram of a bidirectional isolated DC converter according to another embodiment of the present invention. Similar to the embodiment shown in FIG. 9, the power converter is composed of a first AC-DC conversion circuit, a second AC-DC conversion circuit and an isolated resonant network, in order to simplify this specification, only a brief description of similar parts is given. The first AC-DC conversion circuit is composed of switch transistors S1, S2, S3, and S4 to form a full bridge circuit, and the midpoint of the two bridge arms of the full-bridge circuit is connected to the first AC port of the isolated bidirectional resonant network; the second AC-DC conversion circuit is composed of switch transistors S5, S6, S7, and S8 to form a full bridge circuit, and the midpoint of the two bridge arms of the full bridge circuit is connected to the second AC port of the isolated bidirectional resonant network; the isolated resonant network includes a first inductor L₁, a first capacitor C₁, a first AC port, a second AC port, and a transformer T₁, the first inductor L₁ and the first capacitor C₁ are connected in series, one end of the first inductor L₁ is connected to the first AC end of the first AC port, one end of the first capacitor C₁ is connected to the first AC end of the primary side of the transformer T₁, the second AC end of the primary side of the transformer T₁ is connected to the second AC end of the first AC port, the two ports of the secondary side of the transformer T₁ are connected to the two ports of the second AC port, a tap is drawn from the middle of the primary winding of the transformer T₁, an auxiliary capacitor C₂ is connected between the tap and the second AC end of the primary side of the transformer T₁, the excitation inductance of the transformer T₁ is divided into two excitation inductances by the tap: the first excitation inductance Lₘ₁ and the second excitation inductance Lₘ₂, the second excitation inductance Lₘ₂ and the auxiliary capacitor C₂ are connected in parallel and connected in series with the first excitation inductance Lₘ₁ to form an equivalent excitation branch.

In one embodiment of the present invention, the bidirectional isolated DC converter has different voltage gain expressions when operating forward and reverse. In one embodiment of the present invention, the voltage gain expression when the bidirectional isolated DC converter operates in the forward direction is:

$${G}_{1} ( {f}_{n} ) = \frac{{V}_{2}}{{V}_{1}} = \frac{1}{\sqrt{{[ 1 + \frac{1}{{k}_{1} + \frac{{k}_{2}}{1 - {m}^{2} {f}_{n}^{2}}} ( 1 - \frac{1}{{f}_{n}^{2}} ) ]}^{2}} + {{Q}^{2} ( {f}_{n} - \frac{1}{{f}_{n}} )}^{2}}$$

Wherein, V₁ is the effective value of the first AC port voltage, V₂ is the effective value of the second AC port voltage, fₙ is the normalized frequency, fₙ=f_{S}/f₁, f_{S} is the operating frequency, m=f₁/f₂, f₁ is the series resonance frequency of the first inductor and the first capacitor, f₁=1/2π\sqrt{L₁C₁}, f₂ is the first The frequency of the parallel resonance of the three inductors and the second capacitor, f₂=1/2π\sqrt{L₃C₂}, Q=\sqrt{L₁/C₁}/R₁, k₁=L₂/L₁, k₂=L₃/L₁, R₁ is the forward load;

The voltage gain expression G₂(fₙ) of the reverse operation of the non-isolated resonant network is calculated as:

$${G}_{2} ( {f}_{n} ) = \frac{{V}_{1}}{{V}_{2}} = \frac{1}{\sqrt{{{Q}^{2} ( {f}_{n} - \frac{1}{{f}_{n}} )}^{2}}}$$

Wherein, Q=\sqrt{L₁/C₁}/R₂, R₂ is the reverse load;

According to the above voltage gain expression, when the parameters of the converter components are determined, by changing the switch frequency of the first and second AC-DC conversion circuits, the voltage gain of the bidirectional isolated DC converter can be changed, so that the voltage of the power interface of the power electronic intelligent battery unit is kept stable when the battery module port voltage changes due to the state of charge of the battery.

FIG. 11 shows a schematic circuit diagram of a bidirectional isolated DC converter according to still another embodiment of the present invention. Similar to the embodiment shown in FIG. 9, the power converter is composed of a first AC-DC conversion circuit, a second AC-DC conversion circuit and an isolated resonant network, in order to simplify this specification, only a brief description of similar parts is given. The first AC-DC conversion circuit is composed of switch transistors S1, S2, S3, and S4 to form a full bridge circuit, the DC port of the full bridge circuit is V1, and the midpoint of the two bridge arms of the full bridge circuit are connected to the first AC port of the isolated bidirectional resonant network. The second AC-DC conversion circuit is composed of switch transistors S5, S6, S7, and S8 to form a full bridge circuit, the DC port of the full bridge circuit is V2, and the midpoint of the two bridge arms of the full bridge circuit are connected to the second AC port of the isolated bidirectional resonant network; the isolated resonant network includes a first inductor L1, a transformer T1, a first AC port, and a second AC port; wherein, one end of the first inductor L1 is connected to the first AC end of the primary side of the transformer T1, the other end of the first inductor is connected to the first AC end of the first AC port, the second AC end of the primary side of the transformer T1 is connected to the second AC end of the first AC port; the secondary port of the transformer T1 is connected to the second AC port.

In the single phase-shift modulation mode of the power converter, the switches S1 and S4 are turned on or off at the same time, S2 and S3 are turned on or off at the same time, S5 and S8 are turned on or off at the same time, and S6 and S7 are turned on or off at the same time; S1 and S3 are turned on in a complementary manner, S2 and S4 are turned on in a complementary manner, S5 and S7 are turned on in a complementary manner, and S6 and S8 are turned on in a complementary manner; and it is defined that within a switch period, the conduction signal of S1 leads the phase q of the conduction signal of S5. When the transformation ratio of the transformer is n, it can be obtained that the voltage on both sides of the power converter satisfies the following relationship:

$$φ = \frac{π}{2} ( 1 - \sqrt{1 - \frac{8 {fL}_{1} P}{{nV}_{1} {V}_{2}}}$$

Wherein, P is the power transmitted by the converter from the V1 side to the V2 side.

According to the above voltage gain expression, when the parameters of the converter components are determined, by changing the switch frequency and phase angle φ of the first and second AC-DC conversion circuits, the voltage gain of the bidirectional isolated DC converter can be changed, so that the voltage of the power interface of the power electronic intelligent battery unit is kept stable when the battery module port voltage changes due to the state of charge of the battery.

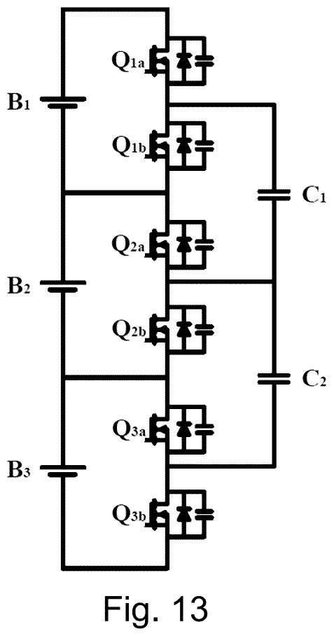

The power converter described in the present invention may also be realized by using a bidirectional non-isolated DC converter. FIG. 12 shows a schematic circuit diagram of a bidirectional non-isolated DC converter according to an embodiment of the present invention. The bidirectional non-isolated DC converter includes first to fourth switch transistors S1, S2, S3, S4, inductor L and capacitors C1, C2. The first switch transistor S1 and the second switch transistor S2 are connected in series to form a half bridge, and a capacitor C1 is connected in parallel; the third switch transistor S3 and the fourth switch transistor S4 are connected in series to form a half bridge, and the capacitor C2 is connected in parallel; the sources of the switch transistors S2 and S4 are connected; the inductor L connects the midpoints of the two half bridge arms.

In one switch period, the switches S1 and S2 are turned on in a complementary manner and the switches S3 and S4 are turned on in a complementary manner. Within a switch cycle, it is defined that the ratio of the on-time of the switch transistor S1 to one switch cycle is the duty cycle D1, and the ratio of the on-time of the switch transistor S3 to one switch cycle is the duty cycle D2, according to the steady-state conditions of the inductor, the voltage gain of the bidirectional non-isolated DC converter may be calculated in the continuous current mode of the inductor.

$$G = \frac{{V}_{2}}{{V}_{1}} = \frac{{D}_{1}}{{D}_{2}}$$

According to the above voltage gain expression, when the parameters of the converter components are determined, by the duty cycle D1 and the duty cycle D2, the voltage gain of the bidirectional non-isolated DC converter can be changed, so that the voltage of the power interface of the power electronic intelligent battery unit is kept stable when the battery module port voltage changes due to the state of charge of the battery.

Multiple embodiments of the power converter of the present invention have been described above in conjunction with FIG. 9 to FIG. 12, and those skilled in the art should understand that the specific embodiments shown in FIG. 9 to FIG. 12 are only used to schematically illustrate the power converter of the present invention, but not to limit the specific circuit structure of the power converter of the present invention. Therefore, in other embodiments of the present invention, the power converter can adopt other forms of circuit structure, as long as the bidirectional converter that can realize similar functions can be used as the power converter described in the present invention, which falls within the scope of the present invention protected range.

Returning to FIG. 7, the power converter 709 may also include an auxiliary power supply 714. The auxiliary power supply 714 may provide power for the processor, the driving circuit of the power converter, the protection device, the cooling device and the balance circuit.

In an embodiment of the present invention, the protection device 710 may be a relay, a fuse or the like. The protection device 710 may be installed at the output end of the power electronic intelligent battery module. When the power electronic intelligent battery module needs to be switched out of operation due to internal faults or external commands, the power electronic intelligent battery module can be switched out safely and effectively through the control of the relay. The fuse can be blown after the current exceeds the threshold value to play a protective role.

The balance circuit 711 is arranged at both ends of each battery cell. Through a certain balance algorithm, under the control of the processor, the balance circuit realizes the balance of the state of charge of the battery cells through the switching of the switch transistor. FIG. 13 shows a schematic circuit diagram of a balance circuit according to an embodiment of the present invention. The battery module includes N battery cells connected in series. The balance circuit may include 2N switch transistors and N−1 capacitors. As shown in FIG. 13, only three battery cells B₁ to B₃ are schematically shown, the switch transistors Q₁ₐ and Q_{1b} are connected in series between the positive pole and the negative pole of the first battery cell B₁; the switch transistors Q₂ₐ and Q_{2b} are connected in series between the positive pole and the negative pole of the second battery cell B₂; the switch transistors Q₃ₐ and Q_{3b} are connected in series between the positive pole and the negative pole of the third battery cell B₃; One end of the capacitor C₁ is connected to the connecting terminals of the switch transistors Q₁ₐ and Q_{1b}, and the other end is connected to the connecting terminals of the switch transistors Q₂ₐ and Q_{2b}; one end of the capacitor C₂ is connected to the connecting terminals of the switch transistors Q₂ₐ and Q_{2b}, and the other end is connected to the connecting terminals of the switch transistors Q₃ₐ and Q_{3b}.

Returning to FIG. 7, the cooling device 712 may include heat dissipation structures such as radiators and fans. The radiator 712 is installed on the power converter and the battery module to absorb the heat generated by both, and increase the heat dissipation area. At the same time, the radiator 712 has a unified structure. When the ambient temperature is too low, the additional heat generated by the power converter can be transferred to the battery module to prevent the battery module from being damaged due to low temperature. Under the control of the processor, the fan may adjust the air flow rate of the internal heat dissipation channel of the power electronic intelligent battery unit, improve the efficiency of heat exchange between the radiator and the air, reduce the temperature of the intelligent battery unit, and avoid damage to the battery and converter components due to excessive temperature.

The communication interface 713 serves as a two-way information interaction function with the outside, and can perform local and remote information interaction in wired and wireless forms.

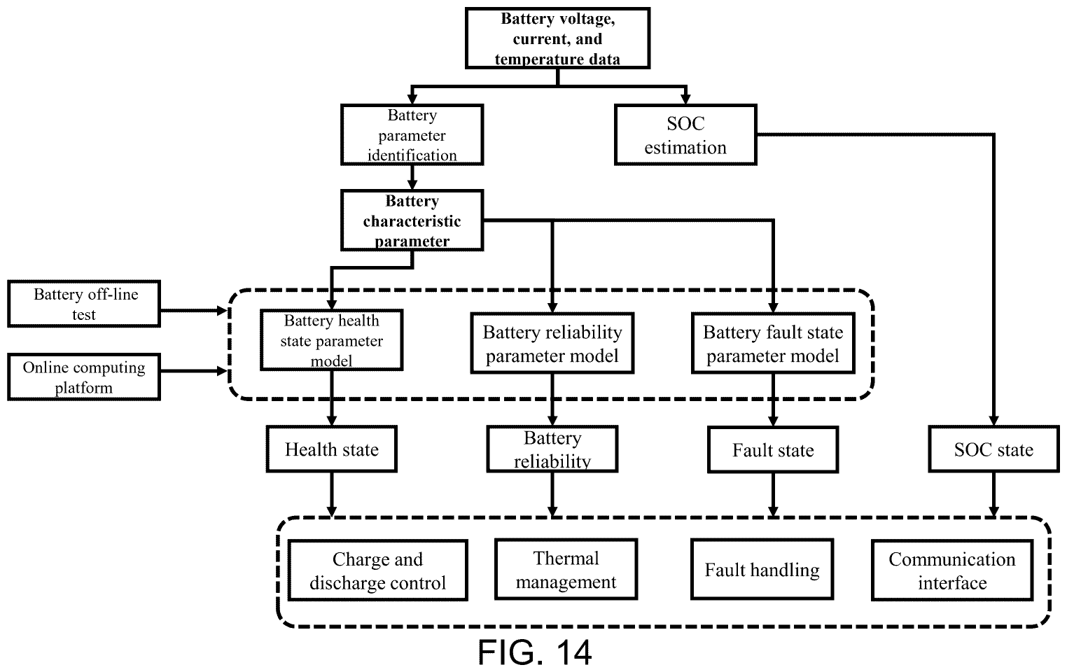

During operation, the processor 702 of the power electronic intelligent battery unit 700 executes software, and the processor 702 may be configured as a parameter identification unit 721, a state estimation unit 722, a fault prediction unit 723, a charge and discharge control unit 724, a balance control unit 725, a converter control unit 726, a fault processing unit 727, a heat dissipation control unit 728, a capacity expansion control unit 729. The processor 702 of the power electronic intelligent battery unit 700 performs information interaction with the online computing platform through the communication interface 713. FIG. 14 shows an overall flowchart of the battery module software portion according to an embodiment of the present invention. The working process of the battery module will be described below with reference to FIG. 14 and each functional unit of the processor 702.

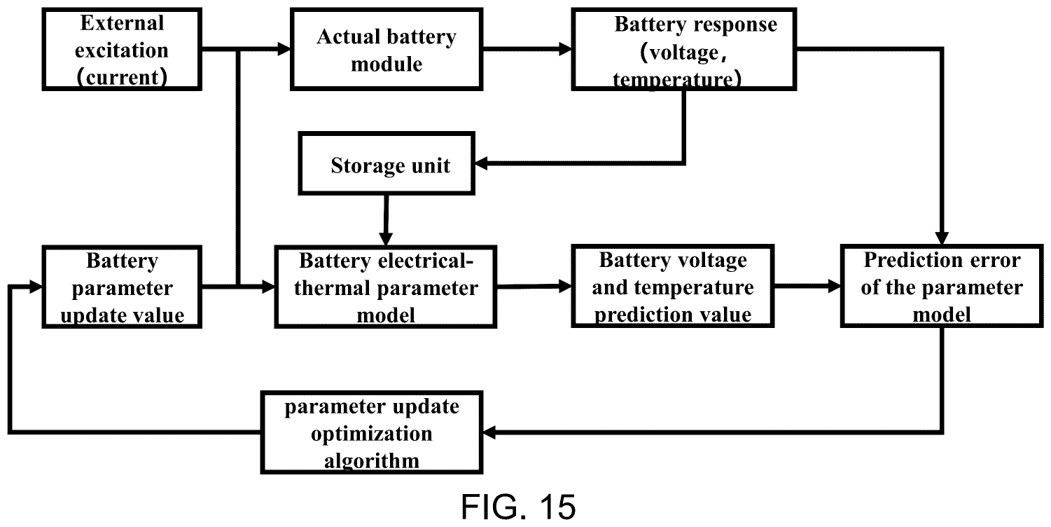

Based on the collected battery voltage, current, and temperature information, combined with various battery parameter models, and using parameter identification algorithms, the parameter identification unit 721 performs online identification and calculation of battery internal parameters involved in various battery parameter models to characterize changes in battery performance. FIG. 15 shows a flowchart of parameter identification according to one embodiment of the present invention. When the external excitation is applied to the battery module, the parameter identification unit will substitute the updated value of the last battery parameter, the current external excitation signal and the battery response history information stored in the storage unit into the battery electric-thermal parameter model to calculate the predicted value of battery end voltage and temperature, compare the predicted value with the current battery voltage and temperature response information, and obtain the prediction error of the parameter model; further use the parameter update optimization algorithm, take reducing the prediction error of the parameter model as the optimization goal and direction, correct and update the parameters in the battery electro-thermal model, and obtain new battery parameter update values which will be applied to the next battery parameter identification process; at the same time, store the current battery information collected by the sensor in the storage unit, which will be applied in the next calculation of the battery response prediction value. The above parameter identification process is carried out continuously during the operation of the battery module, in a short time scale, the battery parameters are considered to be stable, by updating and optimizing the parameters, the error between the predicted value of the parameter model and the actual response is continuously reduced to zero, so as to obtain accurate battery parameters that can reflect the actual characteristics of the battery; in a longer time scale, the battery parameters change with battery charging, discharging and aging, the parameter identification algorithm may track the changes of battery parameters, so as to realize the identification of battery parameters during the battery life cycle, and further estimate the battery health status and battery fault prediction according to the identified parameters.

Based on the collected battery voltage, current, and temperature information, combined with the parameter identification results of the parameter identification unit and the state estimation model, the state estimation unit 722 conducts online estimation of the state of charge of the battery and the battery health state, and uses a filtering algorithm to eliminate random noise and accumulated error in the process of state estimation.

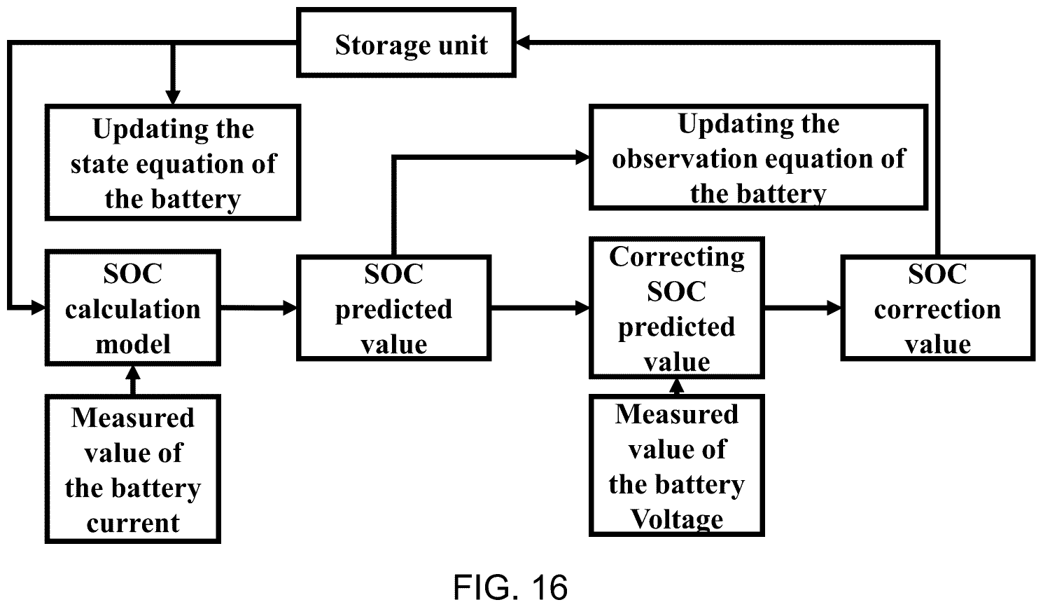

FIG. 16 shows a flowchart of state of charge estimation according to an embodiment of the present invention. The battery state of charge (State of Charge, abbreviated as SOC) indicates the ratio of the current stored charge of the battery to the maximum charge that the battery may store. In the state of charge estimation process, the battery current measurement value is collected by the current sensor and brought into the state of charge (SOC) calculation model, the state of charge calculation model adopts the state equation of the battery, and calculates the predicted value of the current state of charge from the historical value of the state of charge and the measured value of the battery current, due to the error between the historical state of charge and the measured value of the battery, the calculated predicted value of the state of charge needs to be corrected; the state of charge correction method uses the observation equation of the battery, and substitutes the measured value of the current battery voltage obtained by the voltage sensor and the predicted value of the state of charge to obtain the correction value of the state of charge; since the parameters in the battery observation equation will change with the change of the state of charge, before calculating the correction value of the state of charge, the battery observation equation is updated by using the predicted value of the state of charge obtained; similarly, after the correction value of the state of charge is calculated, it is stored in the storage unit, and at the same time, the parameters of the battery state equation required for the next state of charge calculation are updated to complete a cycle of state of charge estimation. As mentioned above, during the operation of the battery, the battery state of charge estimation process is continuously carried out, and the battery state of charge is continuously predicted, corrected and tracked, and the obtained battery state of charge information is further applied to the charge and discharge control and balance management of the battery.

Based on the collected battery voltage, current, and temperature information, combined with the identification results obtained by the parameter identification unit and the battery state obtained by the state estimation unit, the fault prediction unit 723 evaluates the current reliability of the battery, predicts the probability of battery fault in the future and provides reference for the safe and reliable operation of the battery.

According to the results obtained by the state estimation unit and the fault prediction unit, the charge and discharge control unit 724 provides the current maximum allowable value of the charge and discharge current and power of the battery module and the charge and discharge plan.

According to the state of charge data of each battery cell obtained by the state estimation unit, the balance control unit 725 provides the current working mode of the balance circuit, controls the operation of the corresponding switch transistor, and realizes the balance of the voltage between the battery cells.

According to the current battery module voltage and the given power command, the converter control unit 726 controls the voltage gain and power of the converter, and provides a stable and controllable output voltage and charge and discharge power at the output port of the power electronic intelligent battery module.

According to the collected battery voltage, current, temperature and pressure information, the fault processing unit 727 determines whether the battery module breaks down, and when it is determined that the battery module breaks down, takes corresponding fault processing operations to avoid the occurrence of thermal runaway of the battery, and sends a fault signal to the outside world.

According to the collected temperature information of the battery and the power converter, the cooling control unit 728 controls the current speed of the fan. And when the ambient temperature is too low, the converter will be actively controlled to generate excess heat to increase the temperature of the entire power electronic intelligent battery module to avoid damage to the battery due to low temperature.

The capacity expansion control unit 729 operates when multiple power electronic intelligent battery modules are connected in series and parallel to expand capacity, and plays an overall control role on the multiple power electronic intelligent battery modules participating in capacity expansion. Through information interaction with each intelligent battery module, according to the charge and discharge power boundary conditions given by the charge and discharge control unit of each intelligent battery module and the efficiency curve of each battery module, the capacity expansion control unit 729 determines the charge and discharge power provided by each intelligent battery module in the capacity expansion system, so as to realize the overall operation with optimal safety and efficiency.

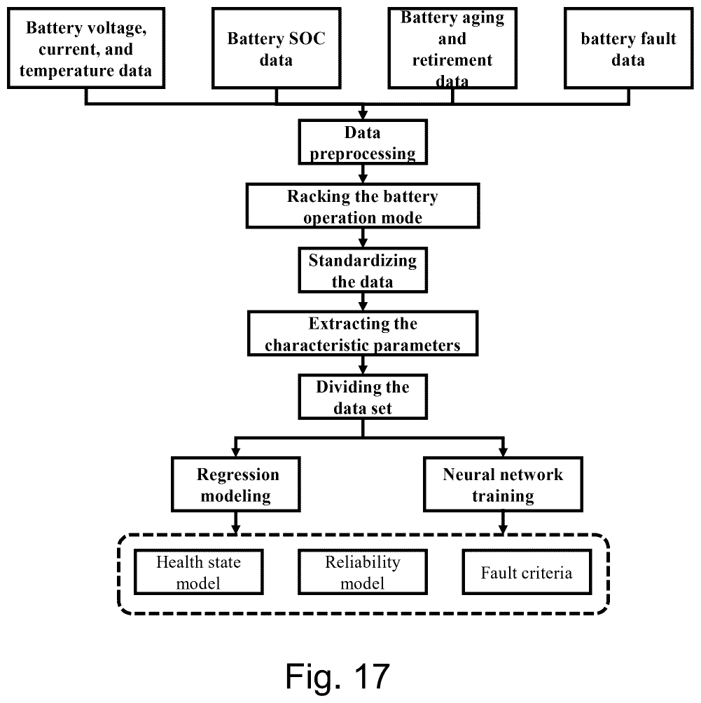

The online computing platform collects parameters and state traces of a large number of power electronic intelligent battery modules during repeated cycle operation through remote communication with a large number of power electronic intelligent battery modules, and through big data mining and intelligent algorithms, corrects and optimizes the parameter models, state estimation algorithms, fault prediction algorithms, and charge and discharge control algorithms of batteries in different working environments, and periodically sends the results to each intelligent battery module to improve the accuracy and calculation speed of parameter identification, status evaluation and fault prediction, and improves the efficiency and reliability of intelligent battery module operation. FIG. 17 shows a flow diagram of the online platform according to one embodiment of the present invention. First, a large number of parameters and status traces of power electronic intelligent battery modules in repeated cycle operation are collected, including battery voltage, current, temperature data, battery state of charge data, battery aging and retirement data, battery fault data, etc. Then, preprocessing the collected data, racking the battery operation mode, standardizing the data, extracting the characteristic parameters, and dividing the data set are performed. Next, the regression modeling and neural network training are performed to obtain the health state model, reliability model and fault criteria.

The electronic intelligent battery unit formed by the above embodiments may deeply integrate the structure and function of the battery management system and the power converter.

First, the deep integration of circuit structures.

In terms of hardware architecture, the measurement circuit, balance circuit, and low-voltage side port of the power converter of the battery management system are all built around the battery module, which may realize the unified design of the circuit structure. The voltage and current sensors used by the battery management system to measure battery information may be multiplexed with the voltage and current sensors required by the power converter to achieve closed-loop control. The power converter can simultaneously provide auxiliary power for the processor, measurement circuit, and balance circuit of the battery management system. The deep integration of the circuit structure can reduce the hardware cost of the power electronic intelligent battery module, and bring the compactness and modularity of the hardware design.

Second, the deep integration and interaction of information.

In order to realize real-time monitoring of battery information, as well as parameter identification, state estimation, fault prediction and judgment of the battery, the battery management system needs to monitor the voltage, current and temperature information of the battery module. Similarly, in order to realize the closed-loop control of the high-voltage side voltage and charge and discharge power, the power converter also needs to detect the voltage and current information of the battery. As for the control information, in order to realize the charge and discharge control, the battery management system needs to transmit the setting instructions of the charge and discharge power and current to the control unit of the power converter, and then drive the switch device of the power converter after generating the corresponding modulation waveform to realize the adjustment of charge and discharge power; when the battery management system judges that the intelligent battery module needs to quit operation, in addition to directly controlling the outlet relay, it also needs to send a drive blocking signal to the power converter. The power converter also needs to obtain the battery module equivalent circuit parameters obtained by the battery parameter identification unit, so as to improve the dynamic performance of the closed-loop control. Therefore, the battery management system and the power converter realize real-time sharing and interaction of information, and may realize the high-speed transmission and sharing of the above information by sharing the processor or memory unit, thereby saving information communication costs, and improving the information interaction speed and reliability of the intelligent battery module, realizing real-time tracking of the state change of the battery module, and realizing fast and reliable response to the control instructions given by the outside world.

Third, the deep integration of thermal management.

The battery module has a high sensitivity to temperature. Excessively high temperature will lead to accelerated aging of the battery module, decomposition of electrode active materials and even thermal runaway of the battery; excessively low temperature will lead to a decrease in battery capacity, growth of metal dendrites, and even diaphragm damage and internal short circuit. Therefore, the battery management system needs to monitor the temperature of the battery module, and respond and deal with the high temperature or low temperature in time. During the operation of the power electronic intelligent battery unit, the internal resistance of the battery module and the loss generated by the power converter components will generate heat inside the intelligent battery unit, which requires the installation of a radiator and a fan for heat dissipation. Through the unified design and packaging of the hardware, the battery module and the power transmission unit may share the radiator and fan, thereby reducing the size, weight and cost of the radiator, and increasing the effective heat dissipation area of each part. In terms of thermal management, the thermal management unit may manage the temperature of the intelligent battery module uniformly through the temperature sensors arranged around the key parts of the battery module and power sensor, effectively avoiding excessive accumulation of heat. At the same time, when running in a low-temperature environment, the thermal management unit may also control the power converter to adopt a low-efficiency working and modulation mode to generate excess heat, and provide this part of the heat to the battery module through a unified heat dissipation package to avoid battery module damage due to low temperature.

Fourth, deep integration of reliability management.

The traditional battery module only has a battery monitoring unit, which itself may only realize the state monitoring of the battery module, and is in a passive operation position in the entire energy storage system, since only the PCS at the outlet of the large-capacity battery energy storage system is used as the power converter, the output power of each battery module in the energy storage system is automatically allocated by the state of charge, open circuit voltage and internal impedance of each battery module, even if the battery monitoring unit finds that the battery module deviates from the normal operating state, it cannot take effective measures to change the abnormal operating state, therefore, it is easy to cause the battery module to be in over-charge, over-discharge and over-temperature operation for a long time, further accelerating the aging and damage of the battery, reducing the life and reliability of the entire energy storage system, and increasing the probability of fault. The power electronic intelligent battery module enables the intelligent battery module to actively control and adjust the power and temperature of the battery module through the deep integration of the battery management system and the power converter. When the intelligent battery module detects that the battery module deviates from the normal operating state, it may actively control the power converter to reduce the charge and discharge power of the battery to prevent the battery from being over-charged or over-discharged; when the temperature of the battery module is too high, the current of the intelligent battery module may be reduced, the heat loss of the power converter and the internal resistance of the battery module may be reduced, and the fan speed may be increased to reduce the temperature of the intelligent battery module. According to the prediction results of the battery fault prediction unit of the intelligent battery module, the intelligent battery module may set the upper limit of the charge and discharge power of the battery module and the duration of the peak charge and discharge power in real time, which makes the battery module always work in a high-reliability operating mode, avoids the accelerated aging of the battery module and the continuous aggravation of internal damage, prolongs the working life of the battery module, and avoids the occurrence of battery module faults as much as possible. According to the characteristics of the battery and the characteristics that the energy storage battery is not susceptible to mechanical damage, most of the faults of the battery in the energy storage system come from the internal structural damage of the battery caused by overcharge, over-discharge, and high-temperature and low-temperature operation, such faults often have a long evolution and development process. By effectively identifying and predicting the characteristics of such damage and aging, and actively controlling the derating operation of the battery module, the reliability of battery operation may be effectively improved. Even when the battery fails, the heat generated by the decomposition of active materials and electrolyte requires a certain accumulation process to cause thermal runaway. At the same time, the total heat released by the battery during the fault process is related to the power stored inside the battery. Therefore, through the active control of the intelligent battery unit, the operating power and stored charge of the battery module are actively reduced before the fault occurs, effective heat dissipation is performed when the fault occurs, and the temperature and heat production of the battery module are controlled below the threshold, which may prevent the battery module from thermal runaway, improve the reliability of the intelligent battery module operation, and avoid large-scale faults of the energy storage system.

Fifth, the deep integration of the battery test system.

As the battery module continues to participate in the charge and discharge cycle in the energy storage system, the battery will continue to age, and the internal parameters will continue to change. In order to avoid the error caused by the parameter identification algorithm, the power electronic intelligent battery module may use the characteristics of the deep integration power converter to generate a controllable charge and discharge current when the battery module is in the standby state in the energy storage system, and simulate the off-line test conditions, therefore, at each stage of the life cycle of the battery module, the parameter identification unit may be provided with the measurement samples required for testing key parameters, in this way, the tracking, identification and calibration of key parameter changes may be realized, the parameter identification accuracy of intelligent battery module may be improved, and reliable data support may be provided for state estimation, fault prediction and judgment functions.

The power electronic intelligent battery unit formed by the above embodiments has excellent uniformity and easy expandability.

When the state of charge and aging degree of the battery module change, the open circuit voltage and internal impedance of the battery module will also change accordingly. Through the power electronic intelligent battery interface, when the characteristics of the battery module change, it can actively control the power converter to adjust the voltage gain and control parameters, through the rapid interaction of battery information and the deep integration of functions, the power electronic intelligent battery interface may realize fast closed-loop control of the external power port of the power electronic intelligent battery module, ensuring stable port voltage and dynamic performance. Therefore, for different battery types, series-parallel scales, state of charge and aging degrees, the power electronic intelligent battery interface may exhibit consistent interface characteristics. Therefore, in the production process of power electronic intelligent battery unit, it is only necessary to ensure the consistency of the battery cells in the module, while the requirements for the consistency of battery cells in different modules are greatly reduced, which may effectively reduce the time cost and labor cost of battery sorting and matching, greatly improve the availability of battery products, and generate considerable economic benefits.

In one embodiment of the present invention, when the power electronic intelligent battery units are connected in parallel to expand capacity, through the consistent interface characteristics provided by the power electronic intelligent battery interface, even if the battery type, capacity, voltage, state of charge and aging degree of each battery module are different, they can be connected in parallel on the DC bus with the same interface voltage, and due to the consistent port characteristics, there will be no circulating current phenomenon between each intelligent battery module, this may effectively improve the cycle efficiency of the parallel expansion system, reduce power loss and battery circulating current loss, and improve the overall benefit of the system. During parallel expansion, the DC bus voltage may be controlled by the grid-connected inverter on the DC bus or a certain intelligent battery unit, and the remaining intelligent battery modules output determined power according to the power distribution algorithm, maintaining the power balance of the DC bus, and realizing efficient and intelligent parallel expansion. When a certain intelligent battery unit needs to be out of operation due to maintenance, replacement or fault, the remaining intelligent battery units only need to redistribute power to realize the normal operation of the power electronic intelligent battery unit parallel expansion system, providing sufficient maintainability, redundancy, and reliability for the system.

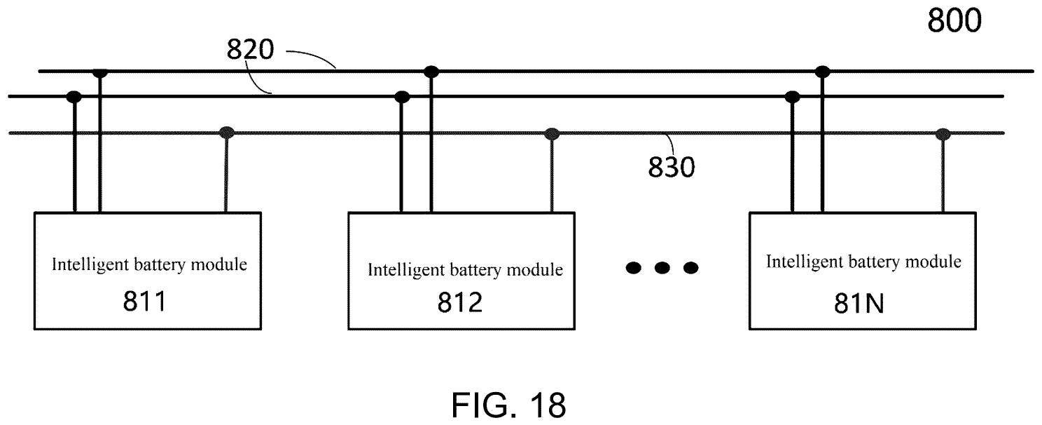

FIG. 18 shows a schematic diagram of a parallel expansion system 800 based on the power electronic intelligent battery unit according to an embodiment of the present invention.

Please refer to FIG. 18, the parallel expansion system 800 based on power electronic intelligent battery units in this embodiment includes: N power electronic intelligent battery units 811, 812 . . . 81N, a DC bus 820 and a communication bus 830. The N power electronic intelligent battery units 811, 812 . . . 81N may be the power electronic intelligent battery units disclosed in the above embodiments of the present invention. The power interfaces of the N power electronic intelligent battery units 811, 812 . . . 81N are connected to the DC bus 820 in parallel. The information interaction interfaces of the N power electronics intelligent battery units 811, 812 . . . 81N are connected to the communication bus 830, upload the status information and fault information of each battery, receive control commands for the power electronic intelligent battery units, and control the plunge-in and switch-out of the battery unit, and the size and direction of the transmitted power.

In another embodiment of the present invention, when the power electronic intelligent battery units are connected in series to expand capacity, through the consistent interface characteristics provided by the power electronic intelligent battery interface, even if the battery type, capacity, voltage, state of charge and aging degree of each battery module are different, they can be connected in series with the same port characteristics. By rationally allocating the port voltage of each series-connected intelligent battery unit, changing the power of each battery unit, avoiding the short-board effect of battery series connection and overcharge and over-discharge of battery modules, the effective capacity and actual life of the series expansion system may be effectively improved, and the overall effectiveness of the system may be improved. When a certain intelligent battery unit needs to be out of operation due to maintenance, replacement or fault, the intelligent battery unit will bypass itself after being cut off, and the remaining intelligent battery units only need to adjust their respective voltage gains to ensure that the bus voltage after series connection remains unchanged, it may realize the normal operation of the power electronic intelligent battery unit series expansion system, provide sufficient maintainability, redundancy and reliability for the system, and realize efficient and intelligent parallel expansion.

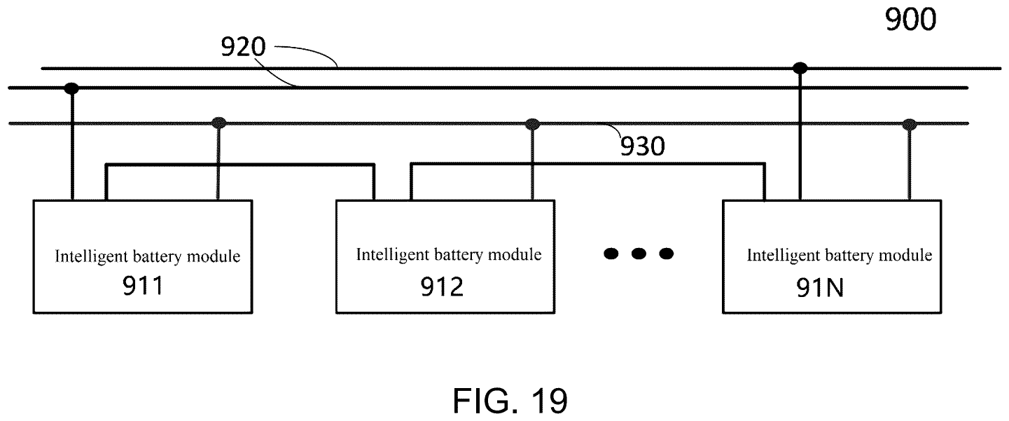

FIG. 19 shows a schematic diagram of a series expansion system 900 based on the power electronic intelligent battery unit according to an embodiment of the present invention.

Please refer to FIG. 19, the series expansion system 900 based on power electronic intelligent battery units in this embodiment includes: N power electronic intelligent battery units 911, 912 . . . 91N, a DC bus 920 and a communication bus 930. The N power electronic intelligent battery units 911, 912 . . . 91N may be the power electronic intelligent battery units disclosed in the above embodiments of the present invention. The power interfaces of N power electronic intelligent battery units 911, 912 . . . 91N are connected in series and then connected to the DC bus 920. The information interaction interfaces of the N power electronics intelligent battery units 911, 912 . . . 91N are connected to the communication bus 930, upload the status information and fault information of each battery, receive control commands for the power electronic intelligent battery units, and control the plunge-in and switch-out of the battery unit, and the size and direction of the transmitted power.

To design a system coordination control strategy for a series-parallel expansion system based on power electronic intelligent battery units, it should meet the following requirements: the system coordination control strategy may ensure the safety of battery operation, and based on the maximum allowable charge and discharge power information provided by each battery unit participating in the expansion, the power allocated to each battery unit is limited within its allowable value; the system coordination control strategy may improve the overall efficiency of battery operation, and based on the data of charge and discharge power and efficiency provided by each battery unit participating in the expansion, the optimization algorithm is applied to calculate the power allocation scheme that makes the overall operating efficiency of the expansion system the highest.

Based on the fault protection method of the intelligent battery unit series-parallel system, the protection logic includes: if a battery unit among the N power electronic intelligent battery units breaks down, its fault information is first detected and obtained by its own battery status monitoring unit, and its own intelligent battery interface completes the active fault isolation of the faulty battery unit; the faulty power electronic intelligent battery unit uploads the battery fault information to the communication bus through the information interaction interface; the power of the power electronic intelligent battery unit that has not failed is redistributed, and the control command it received controls the magnitude and direction of the transmission power of the battery unit to realize the safe and reliable operation of the energy storage system.

The power port of the power electronic intelligent battery unit has unified and controllable port characteristics, so the series-parallel expansion system composed of the power electronic intelligent battery units has the ability to suppress the circulating current between battery modules, eliminating the loss caused by the circulating current between battery modules, therefore, the series-parallel expansion system based on the power electronic intelligent battery unit has the characteristics of no circulating current between modules and high efficiency.

The power port of the power electronic intelligent battery unit has unified and controllable port characteristics, and it is not necessary to ensure the consistency of the battery modules in each intelligent battery unit. It is only necessary to ensure the consistency of the battery cells in a single intelligent battery unit. Since the power and voltage of a single intelligent battery unit is relatively small, and the difficulty in the consistency screening of battery cells is low, the series-parallel expansion system based on the power electronic intelligent battery unit has the characteristics of low screening cost and easy production.

The power electronic intelligent battery unit disclosed in the embodiment of the present invention has excellent intelligent features.

First, the intelligence of the power electronic intelligent battery unit monitoring and evaluation.

The power electronic intelligent battery unit may detect and collect the characteristics and parameters of the battery module under actual operating conditions and simulated test conditions through deeply integrated sensors and controllers. Through advanced parameter identification algorithm, state evaluation algorithm and fault prediction algorithm, the internal parameters, state quantities and reliability of the battery module may be quickly and accurately estimated. By summarizing and aggregating a large amount of battery data in the cloud, data mining and intelligent algorithms may be further used to provide battery parameter models, characteristic parameters, aging curves and fault prediction curves that meet the characteristics of corresponding working conditions for battery modules operating under various actual and complex working conditions. With the operation of the intelligent battery unit, it is possible to describe the changes in the battery module's life cycle based on a large number of data traces, realize intelligent detection and evaluation, and further control and management, thereby improving the efficiency and reliability of battery operation.

Second, the intelligence of power electronics intelligent battery unit fault handling.

On the one hand, the intelligence of power electronics intelligent battery unit fault handling is reflected in the intelligent fault prediction and judgment, through intelligent fault prediction and judgment algorithms and racking algorithms based on big data, accurate and timely prediction and identification may be carried out in the early and subsequent stages of fault, especially for the tiny structural damage inside the battery caused by electrical and thermal abuse, early detection and identification are carried out to prevent problems before they happen. On the other hand, the fault handling of the power electronic intelligent battery unit may actively control and intervene in each stage of the fault through deep integration with the power converter. When the battery fault probability given by the fault prediction unit is high, it may actively reduce the charge and discharge power of the intelligent battery unit in the energy storage system, delay the further development of battery damage, and improve operational reliability; further, it may actively discharge externally, reduce its own stored power, reduce the heat generated when a fault occurs, reduce possible damage, avoid the occurrence of battery thermal runaway, and improve the overall reliability of the system. At the same time, according to the ease of expansion of the above-mentioned power electronic intelligent battery module, when the reliability of a certain battery unit is lower than the threshold, it may quickly arrange for a certain battery unit to be out of operation through the redundancy control of the expansion system, and notify the maintenance personnel to carry out inspection and maintenance, improving the safety and reliability of the system.

Third, the intelligence of the power electronic intelligent battery unit expansion system.

In a traditional battery energy storage system, the voltage and power of each battery module are determined by the state of charge, open circuit voltage and internal impedance of the battery, which may not be actively adjusted and distributed. And the expansion system composed of power electronic intelligent battery units not only has good port consistency and easy scalability, but also has intelligent synergy characteristics. Operational safety and reliability are the primary conditions for the expansion system composed of power electronic intelligent battery units, according to the fault prediction results of each intelligent battery unit, the boundary conditions for its own safe and reliable operation are obtained, when the expansion system distributes power or voltage, it follows the boundary conditions given by each intelligent battery unit to ensure the reliability of the overall system operation and avoid the occurrence of battery overcharge and over-discharge. At the same time, each intelligent battery unit may give its own efficiency and power curves in the case of charge and discharge according to the internal parameters and operating trace information obtained by self-identification, when the power distribution of the expansion system is carried out, the overall system loss may be minimized and the efficiency may be maximized under the premise of ensuring the safety and reliability of the system, so as to realize the unification and combination of safe, reliable and economical and efficient operation.

While various embodiments of the present invention have been described above, it should be understood that they have been presented by way of example only, and not limitation. It will be apparent to the skilled in the relevant art that various combinations, modifications and changes can be made thereto without departing from the spirit and scope of the invention. Thus, the breadth and scope of the present invention disclosed herein should not be limited by the above-disclosed exemplary embodiments, but should be defined only in accordance with the appended claims and their equivalents.

1. A power electronic intelligent battery unit, comprising:
a battery module, the battery module comprising a plurality of battery cells connected in series and a sensor for measuring voltage, current, pressure and/or temperature of the battery cell; and
an intelligent battery interface, connected to an output side of the battery module and a sensor, and having a power interface and an information interface to the outside,
wherein the battery module monitors voltage, current, pressure and/or temperature information of the battery cell, and at the same time provides or absorbs power through the intelligent battery interface.

2. The power electronic intelligent battery unit of claim 1, wherein the intelligent battery interface transmits status information and fault information through an information interface, and receives control information from an information interface,
the intelligent battery interface changes its DC voltage gain according to a voltage of a battery output side of a connected battery module to maintain a voltage stability of a power interface of the power electronic intelligent battery unit.

3. The power electronic intelligent battery unit of claim 1, wherein the sensor comprises one or more of the following items:
a plurality of voltage sensors, temperature sensors and pressure sensors arranged on the battery cells of the battery module, to detect cell voltage, temperature and pressure data of a battery module;
a plurality of voltage sensors and current sensors arranged within the battery module, to detect voltage and current data of the output side of the battery module.

4. The power electronic intelligent battery unit of claim 1, wherein the intelligent battery interface comprises:
a processor;
a conditioning circuit connected to an output end of the sensor, and conditioning an electrical signal output by the sensor to form an electrical signal that can be read by a processor;
a power converter connected to a battery module, enabling bidirectional flow and active control of power according to a control of a processor, and forming a stable and controllable output voltage at the power interface; and
a balance circuit arranged at both ends of each battery cell, and realizing the balance of a state of charge of battery cells by switching a switch transistor, through a certain balance algorithm, under a control of a processor.

5. The power electronic intelligent battery unit of claim 4, wherein the power converter is a bidirectional isolated DC converter, and the bidirectional isolated DC converter has different voltage gain expressions when operating forward and reverse.

6. The power electronic intelligent battery unit of claim 5, wherein the power converter comprises:
a first AC-DC conversion circuit, including a first full bridge circuit composed of first to fourth switch transistors;
a second AC-DC conversion circuit, including a second full bridge circuit composed of fifth to eighth switch transistors; and
an isolated bidirectional resonant network, including a first inductor, a transformer, a first AC port on a primary side of a transformer, and a second AC port on a secondary side of a transformer,
wherein midpoints of two bridge arms of the first full bridge circuit are respectively connected to a first AC end and a second AC end of a first AC port of an isolated bidirectional resonant network, and midpoints of two bridge arms of the second full bridge circuit are respectively connected to a first AC end and a second AC end of the second AC port of an isolated bidirectional resonant network.

7. The power electronic intelligent battery unit of claim 6, wherein the isolated bidirectional resonant network further comprises a second inductor, a first capacitor, a second capacitor, and an auxiliary capacitor, a first inductor and a first capacitor are connected in series, one end of a first inductor is connected to a first AC end of a first AC port, one end of a first capacitor is connected to a first AC end of a primary side of a transformer, a second AC end of a primary side of a transformer is connected to a second AC end of a first AC port, a first AC end of a secondary side of a transformer is connected to one end of a second capacitor, the other end of a second capacitor is connected to one end of a second inductor, the other end of a second inductor is connected to a first AC end of a second AC port, a second AC end of a secondary side of a transformer is connected to a second AC end of the second AC port; a tap is drawn from a middle of a winding on a primary side of a transformer, and a auxiliary capacitor is connected between a tap and a second AC end of a primary side of a transformer.

8. The power electronic intelligent battery unit of claim 6, wherein the isolated bidirectional resonant network further comprises a first capacitor and an auxiliary capacitor, a first inductor and a first capacitor are connected in series, one end of a first inductor is connected to a first AC end of a first AC port, one end of a first capacitor is connected to a first AC end of a primary side of a transformer, a second AC end of a primary side of a transformer is connected to a second AC end of a first AC port, two ports on a secondary side of a transformer are connected to two ports of a second AC port, a tap is drawn from a middle of a winding on a primary side of a transformer, and an auxiliary capacitor is connected between a tap and a second AC end of a primary side of a transformer.

9. The power electronic intelligent battery unit of claim 4, wherein the power converter is a bidirectional non-isolated DC converter, including first to fourth switch transistors, an inductor, a first capacitor and a second capacitor, a first switch transistor and a second switch transistor are connected in series to form a half bridge, and a first capacitor is connected in parallel; a third switch transistor and a fourth switch transistor are connected in series to form a half bridge, and a second capacitor is connected in parallel, and sources of a second switch transistor and a fourth switch transistor are connected; a inductor is connected with midpoints of arms of two half bridges.

10. The power electronic intelligent battery unit of claim 4, wherein the intelligent battery interface further comprises:
a protection device installed at/on a connection end of a intelligent battery interface and a power interface;
a cooling device installed on a power converter and a battery module to absorb a heat generated by the two and increase a heat dissipation area, while the cooling device has a unified structure, to transfer an additional heat generated by a power converter to a battery module, when an ambient temperature is too low, to prevent a battery module from being damaged due to low temperature.

11. The power electronic intelligent battery unit of claim 10, wherein the power converter further comprises an auxiliary power supply that provides power for a processor, a driving circuit of a power converter, a protection device, a cooling device and a balance circuit.

12. The power electronic intelligent battery unit of claim 10, wherein the processor is configured to perform one or more of the following operations:
identifying and calibrating a parameter model of a battery module by measuring, collecting and recording battery voltage, current, pressure and temperature information, and using a variety of parameter identification methods;
estimating and recording a state of charge of a battery by measuring, collecting and recording a battery voltage, current, pressure and temperature information, synthesizing a parameter model of a battery module, and using a variety of charge state estimation methods;
estimating a battery health state by measuring, collecting and recording battery voltage, current, pressure and temperature information, combining a battery state of charge information, and synthesizing a variety of battery health state estimation models;
updating a current equivalent circuit model of a battery module through an estimated battery state of charge and battery health state, and correcting a controller parameters for battery charge and discharge power conversion;
estimating an energy currently stored in a battery and a power boundary of a current charge and discharge of a battery through an estimated battery state of charge and battery health state, and controlling a power of battery charge and discharge;
uploading status information, such as voltage, current, temperature, pressure, etc. of a large number of battery modules, as well as historical charge and discharge cycle records, and fault records, to an online computing platform, through data mining and model training, analyzing a state trace of a battery within a certain period of time before an occurrence of different faults, extracting a characteristic parameters for judging a probability of different faults, and establishing a mathematical model of a characteristic parameters and a probability of fault, establishing a mathematical model to calculate an overall reliability of an intelligent battery unit, and sending a model to each intelligent battery unit through a data bus;
evaluating a historical working trajectory of a battery, analyzing a potential faults, predicting a current health status of a battery, predicting possible faults and fault types, and giving fault prediction information;
calculating a current reliability of a battery module by using a state information, such as its own voltage, current, temperature, pressure, etc., historical charge and discharge cycle records, according to a fault prediction model and reliability model, and actively warning and reducing operation power for intelligent battery units whose reliability is lower than a requirement;
determining whether a battery breaks down at a moment by using a state information, such as its own voltage, current, temperature, pressure, etc., historical charge and discharge cycle records, according to a fault prediction model; when determining that a battery breaks down, taking a module out of an operating state, and taking active cooling measures to avoid thermal runaway of a module, and sending fault information through a communication interface;
comparing a voltage on an output side of a battery module obtained by a voltage sensor with a voltage on a power interface of a power electronic intelligent battery module, when a power of a battery module decreases as a battery discharges and a voltage at an output side of a battery module decreases, increasing a DC voltage gain to keep a voltage of a power interface unchanged; when a power of a battery module increases with battery charging and a voltage at an output side of a battery module rises, reducing a DC voltage gain to keep a voltage of a power interface unchanged;
monitoring a power transmitted by an intelligent battery interface by a voltage sensor and a current sensor, and changing a magnitude and direction of a output current of a battery module, so that a magnitude and direction of an output power of a power electronic intelligent battery module meet a set requirements.

13. The power electronic intelligent battery unit of claim 1, wherein the intelligent battery interface is connected to an online computing platform, the online computing platform collects parameters and state traces of a large number of power electronic intelligent battery modules during repeated cycle operation through remote communication with a large number of power electronic intelligent battery modules, and through big data mining and intelligent algorithms, corrects and optimizes the parameter models, state estimation algorithms, fault prediction algorithms, and charge and discharge control algorithms of batteries in different working environments, and periodically sends the results to each intelligent battery module.

14. An intelligent battery interface connected to an output side of a battery module and a sensor, and connected to a power interface and an information interaction interface, and comprising:
a processor;
a conditioning circuit connected to an output end of the sensor, and conditioning an electrical signal output by the sensor to form an electrical signal that can be read by a processor;
a power converter connected to a battery module, enabling bidirectional flow and active control of power according to a control of a processor, and forming a stable and controllable output voltage at the power interface; and
a balance circuit arranged at both ends of each battery cell, a balance circuit realizing a balance of a state of charge of battery cells by switching a switch transistor, through a certain balance algorithm, under a control of a processor.

15. The intelligent battery interface of claim 14, further comprising:
a protection device installed at a connection end of an intelligent battery interface and a power interface;
a cooling device installed on a power converter and a battery module to absorb a heat generated by the two and increase a heat dissipation area, while the cooling device has a unified structure, to transfer an additional heat generated by a power converter to a battery module, when an ambient temperature is too low, to prevent a battery module from being damaged due to low temperature.

16. The intelligent battery interface of claim 15, further comprising an auxiliary power supply providing power for a processor, a driving circuit of a power converter, a protection device, a cooling device and a balance circuit.

17. A battery system composed of the power electronic intelligent battery unit according to claim 1, comprising:
a plurality of the power electronic intelligent battery units, a DC bus and a communication bus,
wherein power interfaces of the plurality of power electronic intelligent battery units are connected to the DC bus in parallel, or power interfaces of the plurality of power electronics intelligent battery units are connected in series and then connected to the DC bus;
information interaction interfaces of the plurality of power electronic intelligent battery units are connected to the communication bus, upload a status information and fault information of each battery, receive control commands for power electronic intelligent battery units, and control a plunge-in and switch-out of a battery unit, and a size and direction of a transmitted power.

18. The battery system of claim 17, wherein a power of each power electronic intelligent battery unit is determined based on a battery status information provided by a plurality of the power electronic intelligent battery units, and a control strategy for each unit is determined in combination with a power interface control method of the power electronic intelligent battery unit.

19. The battery system of claim 17, wherein when a battery unit among a plurality of the power electronic intelligent battery units breaks down, its fault information is first detected and acquired by its own battery state monitoring unit, and its own intelligent battery interface performs a active fault isolation of the faulty battery unit;
a faulty power electronic intelligent battery unit uploads a battery fault information to a communication bus through an information interaction interface;
a power of a power electronic intelligent battery units that do not break down is redistributed, and a control command it receives controls a magnitude and direction of a transmission power of a battery units.
